(19) United States
(12) Patent Application Publication
(10) Pub. No.: US 2026/0138875 A1
(43) Pub. Date: May 21, 2026

(54) Methods And Systems For Processing And Recycling Of Carbonaceous Materials

(71) Applicant: Nanotech Energy, Inc., Sunny Isles Beach, FL (US)

(72) Inventors: Maher F. EL-KADY, Los Angeles, CA (US); Zhiwei PENG, Chico, CA (US)

(21) Appl. No.: 19/449,235

(22) Filed: Jan. 14, 2026

Related U.S. Application Data
(63) Continuation of application No. PCT/US24/43561, filed on Aug. 23, 2024.
(60) Provisional application No. 63/578,857, filed on Aug. 25, 2023.

(51) Int. Cl. C01B 32/174; B01D 11/04; C01B 32/18; C01B 32/19; C01B 32/225; C01D 15/00; C22B 26/12

(52) U.S. Cl. CPC C01B 32/174; B01D 11/04; C01B 32/18; C01B 32/19; C01B 32/225; C01D 15/00; C22B 26/12; C01P 2004/136

(57) ABSTRACT

Provided herein are methods of processing carbonaceous compositions, recycling battery materials, and producing lithium and/or graphene from carbonaceous compositions or spend battery materials. Also disclosed herein are compositions formed from carbonaceous materials and recycled battery materials. The methods may include disposing carbonaceous electrodes in a fluid to form a composition, carbonaceous electrodes comprising graphite, separating a fluid from the composition; combining the fluid with an alkaline composition to form a precipitate, combining with an acidic composition, filtering the acidic composition, combining a surfactant; and shearing to form a dispersion, the dispersion comprising graphene.

### CROSS REFERENCE TO OTHER APPLICATION(S)

This application is a continuation of PCT/US 2024/043561, filed 2024Aug. 23, which claims the benefit of U.S. Provisional Application No. 63/578,857, filed 2023Aug. 25, both of which are incorporated herein in their entirety by reference.

### BACKGROUND

With the rapid advance on wearable electronic devices and electric vehicles, the need for Li-ion batteries (LIBs) is skyrocketing, pushing the global production of LIBs to over 700 GWh in 2020. Meanwhile, the recycling of spent LIBs has attracted increasing attention not only due to concerns on the environmental pollution, but also because of the huge potential economic advantages. By 2025, the quantity of spent LIBs is expected to reach over 1.3 million tons in the world, mostly from retired electric vehicles. As a result, the global LIBs recycling market is estimated to generate $ 4.78 billion in 2022 and continue to grow at a compound annual growth rate of over 20% to reach $ 21.2 billion by 2030.

### SUMMARY

While methods to recycle lithium ion and other transition metals (e.g., Fe, Co, Ni, and Mn) from cathodes of lithium-ion batteries (LIBs) have been proposed, such methods are incapable of recycling graphite from recycling of LIB anode materials. Further, the recycling of anode materials, which mainly includes graphite, traditionally a less valuable material, is generally overlooked. While extracted graphite has lower monetary value than the cathode's transitions metals, it is appreciated by the inventors that its exposure to lithium intercalation and deintercalation through multiple charging/discharging cycles permits its further exfoliation to produce valuable, two-dimensional, single-layer, graphene. While graphene is currently formed by chemical oxidation and thermal annealing, which may introduce defects and vacancies to the graphene's basal plane. By contrast, the exfoliation of graphite into graphene through intercalation and deintercalation can form pristine graphene sheets. The lack of defects can provide for outstanding electrical, chemical, and mechanical performance for various applications, for example, including conductive coatings, biomedical sensors, and structural composites.

As such, provided herein are methods for processing carbonaceous compositions, for example, to exfoliate carbonaceous compositions with graphite intercalation compounds into graphene. In some embodiments, the methods herein react graphite in an anode, a cathode, or both, with an alkali metal (e.g., potassium and sodium/potassium alloys) to form a graphite intercalation compound, which is sonicated in a solvent to yield a dispersion of carbon nanoparticles (e.g., nanoscrolls and nanoplatelets). For instance, graphite anodes from lithium-ion batteries that are charged before recycling, show higher degrees of intercalation by lithium ions. Together with recovery of other components in the anode, such as for example, copper foil and lithium, the methods herein provide a beneficial technical effect of enabling the recovery and/or recycling of anode materials from spent LIBs into commercially useful products which can be reused in further applications, and which provide sustainable value.

Provided herein is a method for recycling battery materials, the method comprising: combining a first carbonaceous composition with a first acidic composition to form a second acidic composition, the first carbonaceous composition comprising carbonaceous material comprising graphite; filtering the second acidic composition to form a second carbonaceous composition; combining a surfactant with the second carbonaceous composition to form a third carbonaceous composition; and shearing the third carbonaceous composition to form a dispersion, the dispersion comprising graphene. In some embodiments, the method further comprises: disposing one or more carbonaceous electrodes in a first fluid to form a primary composition, the one or more carbonaceous electrodes comprising graphite; separating a second fluid from the composition; and combining the second fluid with an alkaline composition to form a precipitate. In some embodiments, the method further comprises separating the third carbonaceous composition to obtain a fourth carbonaceous composition, the fourth carbonaceous composition comprising graphite. In some embodiments, shearing the third carbonaceous composition comprises shearing the third carbonaceous composition at a rate of at least about 5,000 revolutions per minute (RPM), 6,000 rpm, 7,000 rpm, 8,000 rpm, 9,000 rpm, 10,000 rpm, or more, including increments therein.

In some embodiments, combining the surfactant with the second carbonaceous composition comprises adding the surfactant to a final concentration (% w/w) of about 0.05% to about 10 %. In some embodiments, combining the surfactant with the second carbonaceous composition comprises adding the surfactant to a final concentration (% w/w) of about 0.05% to about 0.1%, about 0.05% to about 0.5%, about 0.05% to about 1%, about 0.05% to about 2%, about 0.05% to about 4%, about 0.05% to about 6%, about 0.05% to about 8%, about 0.05% to about 10%, about 0.1% to about 0.5%, about 0.1% to about 1%, about 0.1% to about 2%, about 0.1% to about 4%, about 0.1% to about 6%, about 0.1% to about 8%, about 0.1% to about 10%, about 0.5% to about 1%, about 0.5% to about 2%, about 0.5% to about 4%, about 0.5% to about 6%, about 0.5% to about 8%, about 0.5% to about 10%, about 1% to about 2%, about 1% to about 4%, about 1% to about 6%, about 1% to about 8%, about 1% to about 10%, about 2% to about 4%, about 2% to about 6%, about 2% to about 8%, about 2% to about 10%, about 4% to about 6%, about 4% to about 8%, about 4% to about 10%, about 6% to about 8%, about 6% to about 10%, or about 8% to about 10%, including increments therein. In some embodiments, combining the surfactant with the second carbonaceous composition comprises adding the surfactant to a final concentration (% w/w) of about 0.05%, about 0.1%, about 0.5%, about 1%, about 2%, about 4%, about 6%, about 8%, or about 10%. In some embodiments, combining the surfactant with the second carbonaceous composition comprises adding the surfactant to a final concentration (% w/w) of at least about 0.05%, about 0.1%, about 0.5%, about 1%, about 2%, about 4%, about 6%, or about 8%. In some embodiments, combining the surfactant with the second carbonaceous composition comprises adding the surfactant to a final concentration (% w/w) of at most about 0.1%, about 0.5%, about 1%, about 2%, about 4%, about 6%, about 8%, or about 10%.

In some embodiments, the surfactant comprises an ionic surfactant, an aromatic ionic surfactant, an aromatic non-ionic surfactant, a non-aromatic surfactant, an ionic liquid, or a polymeric surfactant. In some embodiments, the ionic surfactant comprises a hydrocarbon-based ionic surfactant. In some embodiments, the surfactant is present at a concentration of at least about 3 mM, 4 mM, 5 mM, 6, mM, or more, including increments therein. In some embodiments, the surfactant has a critical micelle concentration of at least 1 mM, 2 mM, 3 mM, 4 mM, 5 mM, 6, mM, or more, including increments therein. In some embodiments, the surfactant is present at a concentration above the critical micelle concentration of the surfactant. In some embodiments, adding a surfactant comprises adding sodium cholate (SC), sodium dodecyl sulfate (SDS), sodium lauryl sulfate (SLS), sodium dodecylbenzene sulfonate (SDBS), sodium dihexyl sulfosuccinate (SDSS), sodium deoxycholate, sodium taurodeoxycholate (STDC), dodecyltrimethyl ammonium bromide (DTAB), tetradecyltrimethyl ammonium bromide (TTAB), cetyltrimethyl ammonium bromide (CTAB), Triton X-100, IGEPAL CO-890, arachidic acid, nanocellulose, or any combination thereof. In some embodiments, the surfactant is sodium cholate. In some embodiments, the surfactant comprises an aromatic surfactant, the aromatic surfactant comprising 1-pyrene sulfonic acid sodium salt. In some embodiments, the surfactant comprises an aromatic non-ionic surfactant, the aromatic non-ionic surfactant comprising porphyrins, porphycene, corrphycene, hemiporphycene, isoporphycene, or a combination thereof. In some embodiments, the surfactant comprises a non-aromatic surfactant, the non-aromatic surfactant comprising SDS. In some embodiments, the surfactant comprises an ionic liquid, the ionic liquid comprising 1-hexyl-3-methyl imidazolium hexafluorophosphate (HMIM). In some embodiments, the surfactant comprises a polymeric surfactant, the polymeric surfactant comprising polyvinylpyrrolidone (PVP), polyethylene glycol (PEG), acrylate, acrylamide, cetrimonium bromide, cetylpyridinium chloride, dimethyloctadecylammonium chloride, or a combination thereof. In some embodiments, the surfactant decreases a viscosity of the third carbonaceous composition. In some embodiments, the surfactant promotes dispersion of the third carbonaceous composition. In some embodiments, separating the second fluid comprises removing lithium. In some embodiments, the method further comprises mixing the fourth carbonaceous material with the acidic composition. In some embodiments, the method further comprises heating the composition to a temperature of about 50° C. to about 90° C. In some embodiments, the method further comprises heating the composition to a temperature of about 50° C. to about 55° C., about 50° C. to about 60° C., about 50° C. to about 65° C., about 50°C. to about 70° C., about 50° C. to about 75° C., about 50° C. to about 80° C., about 50° C. to about 85° C., about 50° C. to about 90° C., about 55° C. to about 60° C., about 55° C. to about 65° C., about 55° C. to about 70° C., about 55° C. to about 75°C., about 55° C. to about 80° C., about 55° C. to about 85° C., about 55° C. to about 90° C., about 60° C. to about 65° C., about 60° C. to about 70° C., about 60° C. to about 75° C., about 60° C. to about 80° C., about 60° C. to about 85° C., about 60°C. to about 90° C., about 65° C. to about 70° C., about 65° C. to about 75° C., about 65° C. to about 80° C., about 65° C. to about 85° C., about 65° C. to about 90° C., about 70° C. to about 75° C., about 70° C. to about 80° C., about 70° C. to about 85°C., about 70° C. to about 90° C., about 75° C. to about 80° C., about 75° C. to about 85° C., about 75° C. to about 90° C., about 80° C. to about 85° C., about 80° C. to about 90° C., or about 85° C. to about 90° C., including increments therein. In some embodiments, the method further comprises heating the composition to a temperature of about 50° C., about 55° C., about 60° C., about 65° C., about 70° C., about 75° C., about 80° C., about 85° C., or about 90° C. In some embodiments, the method further comprises heating the composition to a temperature of at least about 50° C., about 55° C., about 60° C., about 65° C., about 70° C., about 75°C., about 80° C., or about 85° C. In some embodiments, the method further comprises heating the composition to a temperature of at most about 55° C., about 60° C., about 65° C., about 70° C., about 75° C., about 80° C., about 85° C., or about 90° C. In some embodiments, the method further comprises: filtering the precipitate; collecting the supernatant; and combining the supernatant with a salt solution to produce a carbonate salt, the salt solution comprising an alkaline composition. In some embodiments, the supernatant comprises lithium. In some embodiments, the alkaline composition comprises a carbonate salt, sodium carbonate, or combinations thereof. In some embodiments, the method further comprises heating the second acidic composition at least at 30° C., 25° C., 20° C., 15° C., 10° C., or less, including increments therein. In some embodiments, the second carbonaceous composition has a pH of less than 1.0, 0.9, 0.8, 0.7, 0.6, 0.5, or less, including increments therein. In some embodiments, the first acidic composition has a pH of less than 0.5, 0.4.5, 0.3.5, 0.2.5, 0.1 or less, including increments therein. In some embodiments, the first acidic composition comprises sulfuric acid, hydrochloric acid, perchloric acid, or a combination thereof. In some embodiments, the method further comprises heating the composition to a temperature of about 20:1 to about 200:1. In some embodiments, the method further comprises heating the composition to a temperature of about 20:1 to about 40:1, about 20:1 to about 60:1, about 20:1 to about 80:1, about 20:1 to about 100:1, about 20:1 to about 120:1, about 20:1 to about 140:1, about 20:1 to about 160:1, about 20:1 to about 180:1, about 20:1 to about 200:1, about 40:1 to about 60:1, about 40:1 to about 80:1, about 40:1 to about 100:1, about 40:1 to about 120:1, about 40:1 to about 140:1, about 40:1 to about 160:1, about 40:1 to about 180:1, about 40:1 to about 200:1, about 60:1 to about 80:1, about 60:1 to about 100:1, about 60:1 to about 120:1, about 60:1 to about 140:1, about 60:1 to about 160:1, about 60:1 to about 180:1, about 60:1 to about 200:1, about 80:1 to about 100:1, about 80:1 to about 120:1, about 80:1 to about 140:1, about 80:1 to about 160:1, about 80:1 to about 180:1, about 80:1 to about 200:1, about 100:1 to about 120:1, about 100:1 to about 140:1, about 100:1 to about 160:1, about 100:1 to about 180:1, about 100:1 to about 200:1, about 120:1 to about 140:1, about 120:1 to about 160:1, about 120:1 to about 180:1, about 120:1 to about 200:1, about 140:1 to about 160:1, about 140:1 to about 180:1, about 140:1 to about 200:1, about 160:1 to about 180:1, about 160:1 to about 200:1, or about 180:1 to about 200:1, including increments therein. In some embodiments, the method further comprises heating the composition to a temperature of about 20:1, about 40:1, about 60:1, about 80:1, about 100:1, about 120:1, about 140:1, about 160:1, about 180:1, or about 200:1. In some embodiments, the method further comprises heating the composition to a temperature of at least about 20:1, about 40:1, about 60:1, about 80:1, about 100:1, about 120:1, about 140:1, about 160:1, or about 180:1. In some embodiments, the method further comprises heating the composition to a temperature of at most about 40:1, about 60:1, about 80:1, about 100:1, about 120:1, about 140:1, about 160:1, about 180:1, or about 200:1.In some embodiments, separating the third carbonaceous composition to obtain a fourth carbonaceous composition comprises centrifuging the third carbonaceous composition to pellet the fourth carbonaceous composition.

In some embodiments, centrifuging the third carbonaceous composition is performed for a time of about 5 minutes to about 30 minutes. In some embodiments, centrifuging the third carbonaceous composition is performed for a time of about 5 minutes to about 10 minutes, about 5 minutes to about 15 minutes, about 5 minutes to about 20 minutes, about 5 minutes to about 25 minutes, about 5 minutes to about 30 minutes, about 10 minutes to about 15 minutes, about 10 minutes to about 20 minutes, about 10 minutes to about 25 minutes, about 10 minutes to about 30 minutes, about 15 minutes to about 20 minutes, about 15 minutes to about 25 minutes, about 15 minutes to about 30 minutes, about 20 minutes to about 25 minutes, about 20 minutes to about 30 minutes, or about 25 minutes to about 30 minutes, including increments therein. In some embodiments, centrifuging the third carbonaceous composition is performed for a time of about 5 minutes, about 10 minutes, about 15 minutes, about 20 minutes, about 25 minutes, or about 30 minutes. In some embodiments, centrifuging the third carbonaceous composition is performed for a time of at least about 5 minutes, about 10 minutes, about 15 minutes, about 20 minutes, or about 25 minutes. In some embodiments, centrifuging the third carbonaceous composition is performed for a time of at most about 10 minutes, about 15 minutes, about 20 minutes, about 25 minutes, or about 30 minutes.

In some embodiments, the graphite powder is derived from charged or discharged graphite anode. Another aspect provided herein is a method for recovering a carbonaceous material from a battery, the method comprising: combining a first carbonaceous composition with a first acidic composition to form a second acidic composition, the first carbonaceous composition comprising carbonaceous material collected from a portion of one or more carbonaceous electrode; filtering the second acidic composition to form a second carbonaceous composition; combining a surfactant with the second carbonaceous composition to form a third carbonaceous composition; shearing the third carbonaceous composition to form a dispersion, the dispersion comprising graphene; separating the third carbonaceous composition to obtain a fourth carbonaceous composition, the fourth carbonaceous composition comprising graphite; and repeating steps (i) to (v) using a residual composition in place of the first carbonaceous composition. In some embodiments, the method further comprising: disposing the one or more carbonaceous electrodes in a first fluid, the electrode comprising graphite, to form a primary composition; separating a second fluid from the primary composition; and mixing the second fluid with an alkaline composition to form a precipitate. In some embodiments, the above step is performed before the step of combining a first carbonaceous composition with a first acidic composition to form a second acidic composition.

In some embodiments, shearing the third carbonaceous composition comprises shearing the third carbonaceous composition at a rate of about 1,000 rpm to about 9,000 rpm. In some embodiments, shearing the third carbonaceous composition comprises shearing the third carbonaceous composition at a rate of about 6,000 rpm to about 7,000 rpm, about 6,000 rpm to about 8,000 rpm, about 6,000 rpm to about 9,000 rpm, about 6,000 rpm to about 1,000 rpm, about 6,000 rpm to about 1,100 rpm, about 6,000 rpm to about 1,200 rpm, about 7,000 rpm to about 8,000 rpm, about 7,000 rpm to about 9,000 rpm, about 7,000 rpm to about 1,000 rpm, about 7,000 rpm to about 1,100 rpm, about 7,000 rpm to about 1,200 rpm, about 8,000 rpm to about 9,000 rpm, about 8,000 rpm to about 1,000 rpm, about 8,000 rpm to about 1,100 rpm, about 8,000 rpm to about 1,200 rpm, about 9,000 rpm to about 1,000 rpm, about 9,000 rpm to about 1,100 rpm, about 9,000 rpm to about 1,200 rpm, about 1,000 rpm to about 1,100 rpm, about 1,000 rpm to about 1,200 rpm, or about 1,100 rpm to about 1,200 rpm, including increments therein. In some embodiments, shearing the third carbonaceous composition comprises shearing the third carbonaceous composition at a rate of about 6,000 rpm, about 7,000 rpm, about 8,000 rpm, about 9,000 rpm, about 1,000 rpm, about 1,100 rpm, or about 1,200 rpm. In some embodiments, shearing the third carbonaceous composition comprises shearing the third carbonaceous composition at a rate of at least about 6,000 rpm, about 7,000 rpm, about 8,000 rpm, about 9,000 rpm, about 1,000 rpm, or about 1,100 rpm. In some embodiments, shearing the third carbonaceous composition comprises shearing the third carbonaceous composition at a rate of at most about 7,000 rpm, about 8,000 rpm, about 9,000 rpm, about 1,000 rpm, about 1,100 rpm, or about 1,200 rpm.

In some embodiments, separating the third carbonaceous composition to obtain a fourth carbonaceous composition comprises centrifuging the third carbonaceous composition.

In some embodiments, centrifuging the third carbonaceous composition is performed at a speed of about 1,000 rpm to about 3,000 rpm. In some embodiments, centrifuging the third carbonaceous composition is performed at a speed of about 1,000 rpm to about 1,250 rpm, about 1,000 rpm to about 1,500 rpm, about 1,000 rpm to about 1,750 rpm, about 1,000 rpm to about 2,000 rpm, about 1,000 rpm to about 2,250 rpm, about 1,000 rpm to about 2,500 rpm, about 1,000 rpm to about 2,750 rpm, about 1,000 rpm to about 3,000 rpm, about 1,250 rpm to about 1,500 rpm, about 1,250 rpm to about 1,750 rpm, about 1,250 rpm to about 2,000 rpm, about 1,250 rpm to about 2,250 rpm, about 1,250 rpm to about 2,500 rpm, about 1,250 rpm to about 2,750 rpm, about 1,250 rpm to about 3,000 rpm, about 1,500 rpm to about 1,750 rpm, about 1,500 rpm to about 2,000 rpm, about 1,500 rpm to about 2,250 rpm, about 1,500 rpm to about 2,500 rpm, about 1,500 rpm to about 2,750 rpm, about 1,500 rpm to about 3,000 rpm, about 1,750 rpm to about 2,000 rpm, about 1,750 rpm to about 2,250 rpm, about 1,750 rpm to about 2,500 rpm, about 1,750 rpm to about 2,750 rpm, about 1,750 rpm to about 3,000 rpm, about 2,000 rpm to about 2,250 rpm, about 2,000 rpm to about 2,500 rpm, about 2,000 rpm to about 2,750 rpm, about 2,000 rpm to about 3,000 rpm, about 2,250 rpm to about 2,500 rpm, about 2,250 rpm to about 2,750 rpm, about 2,250 rpm to about 3,000 rpm, about 2,500 rpm to about 2,750 rpm, about 2,500 rpm to about 3,000 rpm, or about 2,750 rpm to about 3,000 rpm, including increments therein. In some embodiments, centrifuging the third carbonaceous composition is performed at a speed of about 1,000 rpm, about 1,250 rpm, about 1,500 rpm, about 1,750 rpm, about 2,000 rpm, about 2,250 rpm, about 2,500 rpm, about 2,750 rpm, or about 3,000 rpm. In some embodiments, centrifuging the third carbonaceous composition is performed at a speed of at least about 1,000 rpm, about 1,250 rpm, about 1,500 rpm, about 1,750 rpm, about 2,000 rpm, about 2,250 rpm, about 2,500 rpm, or about 2,750 rpm. In some embodiments, centrifuging the third carbonaceous composition is performed at a speed of at most about 1,250 rpm, about 1,500 rpm, about 1,750 rpm, about 2,000 rpm, about 2,250 rpm, about 2,500 rpm, about 2,750 rpm, or about 3,000 rpm.

In some embodiments, centrifuging the third carbonaceous composition is performed for a time of about 5 minutes to about 30 minutes. In some embodiments, centrifuging the third carbonaceous composition is performed for a time of about 5 minutes to about 10 minutes, about 5 minutes to about 15 minutes, about 5 minutes to about 20 minutes, about 5 minutes to about 25 minutes, about 5 minutes to about 30 minutes, about 10 minutes to about 15 minutes, about 10 minutes to about 20 minutes, about 10 minutes to about 25 minutes, about 10 minutes to about 30 minutes, about 15 minutes to about 20 minutes, about 15 minutes to about 25 minutes, about 15 minutes to about 30 minutes, about 20 minutes to about 25 minutes, about 20 minutes to about 30 minutes, or about 25 minutes to about 30 minutes, including increments therein. In some embodiments, centrifuging the third carbonaceous composition is performed for a time of about 5 minutes, about 10 minutes, about 15 minutes, about 20 minutes, about 25 minutes, or about 30 minutes. In some embodiments, centrifuging the third carbonaceous composition is performed for a time of at least about 5 minutes, about 10 minutes, about 15 minutes, about 20 minutes, or about 25 minutes. In some embodiments, centrifuging the third carbonaceous composition is performed for a time of at most about 10 minutes, about 15 minutes, about 20 minutes, about 25 minutes, or about 30 minutes.

In some embodiments, shearing the third carbonaceous composition comprises shearing the third carbonaceous composition for at least two hours, at least three hours, at least four hours or at least five hours. In some embodiments, the method further comprises washing the second carbonaceous composition with water after filtering the second acidic composition. In some embodiments, the method further comprises drying the second carbonaceous composition at a temperature of at least about 50° C., about 60° C., about 70° C., about 80° C., or about 90° C.

In some embodiments, combining the surfactant with the second carbonaceous composition comprises adding the surfactant to a final concentration (% w/w) of about 0.05% to about 10%. In some embodiments, combining the surfactant with the second carbonaceous composition comprises adding the surfactant to a final concentration (% w/w) of about 0.0% to about 0.1%, about 0.05% to about 0.5%, about 0.05% to about 1%, about 0.05% to about 2%, about 0.05% to about 4%, about 0.05% to about 6%, about 0.05% to about 8%, about 0.05% to about 10%, about 0.1% to about 0.5%, about 0.1% to about 1%, about 0.1% to about 2%, about 0.1% to about 4%, about 0.1% to about 6%, about 0.1% to about 8%, about 0.1% to about 10%, about 0.5% to about 1%, about 0.5% to about 2%, about 0.5% to about 4%, about 0.5% to about 6%, about 0.5% to about 8%, about 0.5% to about 10%, about 1% to about 2%, about 1% to about 4%, about 1% to about 6%, about 1% to about 8%, about 1% to about 10%, about 2% to about 4%, about 2% to about 6%, about 2% to about 8%, about 2% to about 10%, about 4% to about 6%, about 4% to about 8%, about 4% to about 10%, about 6% to about 8%, about 6% to about 10%, or about 8% to about 10%, including increments therein. In some embodiments, combining the surfactant with the second carbonaceous composition comprises adding the surfactant to a final concentration (% w/w) of about 0.05%, about 0.1%, about 0.5%, about 1%, about 2%, about 4%, about 6%, about 8%, or about 10%. In some embodiments, combining the surfactant with the second carbonaceous composition comprises adding the surfactant to a final concentration (% w/w) of at least about 0.05%, about 0.1%, about 0.5%, about 1%, about 2%, about 4%, about 6%, or about 8%. In some embodiments, combining the surfactant with the second carbonaceous composition comprises adding the surfactant to a final concentration (% w/w) of at most about 0.1%, about 0.5%, about 1%, about 2%, about 4%, about 6%, about 8%, or about 10%.

In some embodiments, the surfactant comprises a hydrocarbon-based ionic surfactant, an aromatic ionic surfactant, an aromatic non-ionic surfactant, a non-aromatic surfactant, an ionic liquid, or a polymeric surfactant. In some embodiments, the hydrocarbon-based ionic surfactant comprises a C1-C8 hydrocarbon, a C9-C14 hydrocarbon, or C16-C35 hydrocarbon. In some embodiments, the surfactant comprises an aromatic surfactant, the aromatic surfactant comprising 1-pyrene sulfonic acid sodium salt. In some embodiments, the surfactant comprises an aromatic non-ionic surfactant, the aromatic non-ionic surfactant comprising porphyrins, porphycene, corrphycene, hemiporphycene, isoporphycene, or a combination thereof. In some embodiments, the surfactant comprises a non-aromatic surfactant, the non-aromatic surfactant comprising SDS. In some embodiments, the surfactant comprises an ionic liquid, the ionic liquid comprising 1-hexyl-3-methyl imidazolium hexafluorophosphate (HMIM). In some embodiments, the surfactant comprises a polymeric surfactant, the polymeric surfactant comprising polyvinylpyrrolidone (PVP), polyethylene glycol (PEG), acrylate, acrylamide, cetrimonium bromide, cetylpyridinium chloride, dimethyloctadecylammonium chloride, or a combination thereof. In some embodiments, the surfactant is present at a concentration of at least about 3 mM, 3.5 mM, 4 mM, 4.5 mM, 5 mM, 6 mM, or more, including increments therein. In some embodiments, the surfactant has a critical micelle concentration of at least 1 mM, 2 mM, 3 mM, 4 mM, 5 mM, or more, including increments therein. In some embodiments, adding a surfactant comprises adding sodium cholate (SC), sodium dodecyl sulfate (SDS), sodium lauryl sulfate (SLS), myristic acid, palmitic acid, stearic acid, sodium dodecylbenzene sulfonate (SDBS), sodium dihexyl sulfosuccinate (SDSS), sodium deoxycholate, sodium taurodeoxycholate (STDC), dodecyltrimethyl ammonium bromide (DTAB), tetradecyltrimethyl ammonium bromide (TTAB), cetyltrimethyl ammonium bromide (CTAB), Triton X-100, IGEPAL CO-890, arachidic acid, nanocellulose, or any combination thereof. In some embodiments, separating the second fluid comprises separating lithium. In some embodiments, the method further comprises mixing the fourth carbonaceous material with the acidic composition. In some embodiments, the method further comprises heating the composition to a temperature of about 50° C. to about 200° C. In some embodiments, the method further comprises heating the composition to a temperature of about 50° C. to about 55° C., about 50° C. to about 60° C., about 50°C. to about 65° C., about 50° C. to about 70° C., about 50° C. to about 75° C., about 50° C. to about 80° C., about 50° C. to about 85° C., about 50° C. to about 90° C., about 50° C. to about 200° C., about 55° C. to about 60° C., about 55° C. to about 65° C., about 55° C. to about 70° C., about 55° C. to about 75° C., about 55° C. to about 80° C., about 55° C. to about 85° C., about 55° C. to about 90° C., about 55°C. to about 200° C., about 60° C. to about 65° C., about 60° C. to about 70° C., about 60° C. to about 75° C., about 60° C. to about 80° C., about 60° C. to about 85°C., about 60° C. to about 90° C., about 60° C. to about 200° C., about 65° C. to about 70° C., about 65° C. to about 75° C., about 65° C. to about 80° C., about 65°C. to about 85° C., about 65° C. to about 90° C., about 65° C. to about 200° C., about 70° C. to about 75° C., about 70° C. to about 80° C., about 70° C. to about 85°C., about 70° C. to about 90° C., about 70° C. to about 200° C., about 75° C. to about 80° C., about 75° C. to about 85° C., about 75° C. to about 90° C., about 75°C. to about 200° C., about 80° C. to about 85° C., about 80° C. to about 90° C., about 80° C. to about 200° C., about 85° C. to about 90° C., about 85° C. to about 200° C., or about 90° C. to about 200° C., including increments therein. In some embodiments, the method further comprises heating the composition to a temperature of about 50° C., about 55° C., about 60° C., about 65° C., about 70° C., about 75° C., about 80° C., about 85° C., about 90° C., or about 200° C. In some embodiments, the method further comprises heating the composition to a temperature of at least about 50° C., about 55° C., about 60° C., about 65° C., about 70° C., about 75° C., about 80° C., about 85° C., or about 90° C. In some embodiments, the method further comprises heating the composition to a temperature of at most about 55° C., about 60° C., about 65° C., about 70° C., about 75° C., about 80° C., about 85° C., about 90° C., or about 200° C. In. some embodiments, the method further comprises: filtering the precipitate to form a solid; collecting a supernatant, the supernatant comprising lithium; and mixing the supernatant in a salt solution, the salt solution comprising an alkaline composition comprising a carbonate, to produce a carbonate powder. In some embodiments, the method further comprises heating the second acidic composition at least at 30° C., 35° C., 40° C., 45° C., 50° C., 60° C., or more, including increments therein. In some embodiments, the first acidic composition has a pH of less than 1.0, 0.9, 0.8, 0.7, 0.6 or less, including increments therein. In some embodiments, the carbonate powder is lithium carbonate. Another aspect provided herein is a method of forming a graphene dispersion. the method comprises: disposing the one or more carbonaceous electrodes in a first fluid, the electrode comprising graphite, to form a primary composition; separating a first carbonaceous composition from a second fluid from the primary composition; mixing the second fluid with an alkaline composition to form a precipitate; combining the first carbonaceous composition with a first acidic composition to form a second acidic composition, the first carbonaceous composition comprising carbonaceous material collected from a portion of one or more carbonaceous electrode; filtering the second acidic composition to form a second carbonaceous composition; combining a surfactant with the second carbonaceous composition to form a third carbonaceous composition; shearing the third carbonaceous composition to form a dispersion, the dispersion comprising graphene; separating the dispersion to obtain a fourth carbonaceous composition and a residual composition, the fourth carbonaceous composition comprising graphene; and repeating steps (iv) to (viii), wherein combining the first carbonaceous composition with a first acidic composition is configured to produce a graphene dispersion, the graphene dispersion having an increased volume of graphene sheets as compared to an absence of the first acidic composition. In some embodiments, the dispersion comprises a D/G ratio of about 1.0. In some embodiments, the dispersion has a D/G ratio of less than about 1.0. In some embodiments, the dispersion has a D/G ratio of about 0.3. In some embodiments, the dispersion comprises a D/G ratio of about 0.2 to about 1.0. In some embodiments, the dispersion comprises a D/G ratio of about 0.2 to about 0.3, about 0.2 to about 0.4, about 0.2 to about 0.5, about 0.2 to about 0.6, about 0.2 to about 0.7, about 0.2 to about 0.8, about 0.2 to about 0.9, about 0.2 to about 1.0, about 0.3 to about 0.4, about 0.3 to about 0.5, about 0.3 to about 0.6, about 0.3 to about 0.7, about 0.3 to about 0.8, about 0.3 to about 0.9, about 0.3 to about 1.0, about 0.4 to about 0.5, about 0.4 to about 0.6, about 0.4 to about 0.7, about 0.4 to about 0.8, about 0.4 to about 0.9, about 0.4 to about 1.0, about 0.5 to about 0.6, about 0.5 to about 0.7, about 0.5 to about 0.8, about 0.5 to about 0.9, about 0.5 to about 1.0, about 0.6 to about 0.7, about 0.6 to about 0.8, about 0.6 to about 0.9, about 0.6 to about 1.0, about 0.7 to about 0.8, about 0.7 to about 0.9, about 0.7 to about 1.0, about 0.8 to about 0.9, about 0.8 to about 1.0, or about 0.9 to about 1.0. In some embodiments, the dispersion comprises a D/G ratio of about 0.2, about 0.3, about 0.4, about 0.5, about 0.6, about 0.7, about 0.8, about 0.9, or about 1.0. In some embodiments, the first carbonaceous composition has a D/G ratio greater than the D/G of the dispersion. In some embodiments, the method includes recovering a current collector from the one or more carbonaceous electrodes. In some embodiments, recovering the current collector comprises recovering the current collector with no mechanical cracks or damage. In some embodiments, the current collector comprises copper (Cu).

Another aspect provided herein is a graphene dispersion formed from a recycled graphite anode the graphene dispersion comprising graphene, wherein the graphene remains suspended in solution for at least 1, 2, 3, 4, 5, 6, 7, 8, 9, 10, 11, 12 or more months. In some embodiments, the graphene dispersion has a D/G ratio of less than about 1.0. In some embodiments, the graphene dispersion has a D/G of less than about 0.5. In some embodiments, the graphene dispersion has an oxygen content of from about 1.0 wt % to about 8.0 wt %. In some embodiments, the graphene dispersion has an oxygen content of at most 5 wt %. In some embodiments, the graphene dispersion comprises a nitrogen content from about 0.1 wt % to about 5 wt %. In some embodiments, the graphene dispersion comprises a carbon content from about 75% to about 99%. In some embodiments, the graphene dispersion comprises a carbon content from about 75% to about 99%. In some embodiments, the graphene dispersion comprises a carbon content from about 75% to about 80%, about 75% to about 85%, about 75% to about 90%, about 75% to about 95%, about 75% to about 99%, about 80% to about 85%, about 80% to about 90%, about 80% to about 95%, about 80% to about 99%, about 85% to about 90%, about 85% to about 95%, about 85% to about 99%, about 90% to about 95%, about 90% to about 99%, or about 95% to about 99%. In some embodiments, the carbon content is a weight percent (wt %). In some embodiments, the graphene dispersion comprises carbon and oxygen in a ratio of about 20:1, 21:1, 22:1, 23:1, 24:1, or 25:1 (C:O) by weight. In some embodiments, the graphene dispersion has a thermal conductivity of about 0.5 W/mK, about 1.0 W/mK, about 1.5 W/mK, or about 2.0 W/mK. In some embodiments, the graphene dispersion has a thermal conductivity of about 1.0 W/mK to about 2.0 W/mK. In some embodiments, the graphene dispersion has a thermal diffusivity of about 1 mm²/s, about 2 mm²/s, about 3 mm²/s, about 4 mm²/s, or about 5 mm²/s. In some embodiments, the graphene dispersion has a specific heat of about 0.3 MJ/m³K, about 0.4 MJ/m³K, about 0.5 MJ/m³K, about 0.6 MJ/m³K, or about 0.7 MJ/m³K. In some embodiments, the graphene dispersion has a specific heat of about 0.4 MJ/m³K to about 0.6 MJ/m³K. In some embodiments, the graphene dispersion has an average sheet resistance that ranges from about 80 Ohm/sq to about 180 Ohm/sq. In some embodiments, the graphene dispersion has an average sheet resistance that ranges from about 80 Ohm/sq to about 90 Ohm/sq, from about 80 Ohm/sq to about 100 Ohm/sq, from about 80 Ohm/sq to about 110 Ohm/sq, from about 80 Ohm/sq to about 120 Ohm/sq, from about 80 Ohm/sq to about 130 Ohm/sq, from about 80 Ohm/sq to about 140 Ohm/sq, from about 80 Ohm/sq to about 150 Ohm/sq, from about 80 Ohm/sq to about 160 Ohm/sq, from about 80 Ohm/sq to about 170 Ohm/sq, from about 80 Ohm/sq to about 180 Ohm/sq, from about 90 Ohm/sq to about 100 Ohm/sq, from about 90 Ohm/sq to about 110 Ohm/sq, from about 90 Ohm/sq to about 120 Ohm/sq, from about 90 Ohm/sq to about 130 Ohm/sq, from about 90 Ohm/sq to about 140 Ohm/sq, from about 90 Ohm/sq to about 150 Ohm/sq, from about 90 Ohm/sq to about 160 Ohm/sq, from about 90 Ohm/sq to about 170 Ohm/sq, from about 90 Ohm/sq to about 180 Ohm/sq, from about 100 Ohm/sq to about 110 Ohm/sq, from about 100 Ohm/sq to about 120 Ohm/sq, from about 100 Ohm/sq to about 130 Ohm/sq, from about 100 Ohm/sq to about 140 Ohm/sq, from about 100 Ohm/sq to about 150 Ohm/sq, from about 100 Ohm/sq to about 160 Ohm/sq, from about 100 Ohm/sq to about 170 Ohm/sq, from about 100 Ohm/sq to about 180 Ohm/sq, from about 110 Ohm/sq to about 120 Ohm/sq, from about 110 Ohm/sq to about 130 Ohm/sq, from about 110 Ohm/sq to about 140 Ohm/sq, from about 110 Ohm/sq to about 150 Ohm/sq, from about 110 Ohm/sq to about 160 Ohm/sq, from about 110 Ohm/sq to about 170 Ohm/sq, from about 110 Ohm/sq to about 180 Ohm/sq, from about 120 Ohm/sq to about 130 Ohm/sq, from about 120 Ohm/sq to about 140 Ohm/sq, from about 120 Ohm/sq to about 150 Ohm/sq, from about 120 Ohm/sq to about 160 Ohm/sq, from about 120 Ohm/sq to about 170 Ohm/sq, from about 120 Ohm/sq to about 180 Ohm/sq, from about 130 Ohm/sq to about 140 Ohm/sq, from about 130 Ohm/sq to about 150 Ohm/sq, from about 130 Ohm/sq to about 160 Ohm/sq, from about 130 Ohm/sq to about 170 Ohm/sq, from about 130 Ohm/sq to about 180 Ohm/sq, from about 140 Ohm/sq to about 150 Ohm/sq, from about 140 Ohm/sq to about 160 Ohm/sq, from about 140 Ohm/sq to about 170 Ohm/sq, from about 140 Ohm/sq to about 180 Ohm/sq, from about 150 Ohm/sq to about 160 Ohm/sq, from about 150 Ohm/sq to about 170 Ohm/sq, from about 150 Ohm/sq to about 180 Ohm/sq, from about 160 Ohm/sq to about 170 Ohm/sq, from about 160 Ohm/sq to about 180 Ohm/sq, or about 170 Ohm/sq to about 180 Ohm/sq.. In some embodiments, the graphene dispersion has an average sheet resistance of about 80 Ohm/sq, about 90 Ohm/sq, about 100 Ohm/sq, about 110 Ohm/sq, about 120 Ohm/sq, about 130 Ohm/sq, about 140 Ohm/sq, about 150 Ohm/sq, or about 160 Ohm/sq.

In some embodiments, the graphene dispersion has an average resistivity that ranges from about 0.05 Ohm·cm to about 0.5 Ohm·cm. In some embodiments, the graphene dispersion has an average resistivity that ranges from about 0.05 Ohm·cm to about 0.1 Ohm·cm, from about 0.05 Ohm·cm to about 0.15 Ohm·cm, from about 0.05 Ohm·cm to about 0.2 Ohm·cm, from about 0.05 Ohm·cm to about 0.25 Ohm·cm, from about 0.05 Ohm·cm to about 0.3 Ohm·cm, from about 0.05 Ohm·cm to about 0.35 Ohm·cm, from about 0.05 Ohm·cm to about 0.4 Ohm·cm, from about 0.05 Ohm·cm to about 0.45 Ohm·cm, from about 0.05 Ohm·cm to about 0.5 Ohm·cm, from about 0.1 Ohm·cm to about 0.15 Ohm·cm, from about 0.1 Ohm·cm to about 0.2 Ohm·cm, from about 0.1 Ohm·cm to about 0.25 Ohm·cm, from about 0.1 Ohm·cm to about 0.3 Ohm·cm, from about 0.1 Ohm·cm to about 0.35 Ohm·cm, from about 0.1 Ohm·cm to about 0.4 Ohm·cm, from about 0.1 Ohm·cm to about 0.45 Ohm·cm, from about 0.1 Ohm·cm to about 0.5 Ohm·cm, from about 0.15 Ohm·cm to about 0.2 Ohm·cm, from about 0.15 Ohm·cm to about 0.25 Ohm·cm, from about 0.15 Ohm·cm to about 0.3 Ohm·cm, from about 0.15 Ohm·cm to about 0.35 Ohm·cm, from about 0.15 Ohm·cm to about 0.4 Ohm·cm, from about 0.15 Ohm·cm to about 0.45 Ohm·cm, from about 0.15 Ohm·cm to about 0.5 Ohm·cm, from about 0.2 Ohm·cm to about 0.25 Ohm·cm, from about 0.2 Ohm·cm to about 0.3 Ohm·cm, from about 0.2 Ohm·cm to about 0.35 Ohm·cm, from about 0.2 Ohm·cm to about 0.4 Ohm·cm, from about 0.2 Ohm·cm to about 0.45 Ohm·cm, from about 0.2 Ohm·cm to about 0.5 Ohm·cm, from about 0.25 Ohm·cm to about 0.3 Ohm·cm, from about 0.25 Ohm·cm to about 0.35 Ohm·cm, from about 0.25 Ohm·cm to about 0.4 Ohm·cm, from about 0.25 Ohm·cm to about 0.45 Ohm·cm, from about 0.25 Ohm·cm to about 0.5 Ohm·cm, from about 0.3 Ohm·cm to about 0.35 Ohm·cm, from about 0.3 Ohm·cm to about 0.4 Ohm·cm, from about 0.3 Ohm·cm to about 0.45 Ohm·cm, from about 0.3 Ohm·cm to about 0.5 Ohm·cm, from about 0.35 Ohm·cm to about 0.4 Ohm·cm, from about 0.35 Ohm·cm to about 0.45 Ohm·cm, from about 0.35 Ohm·cm to about 0.5 Ohm·cm, from about 0.4 Ohm·cm to about 0.45 Ohm·cm, from about 0.4 Ohm·cm to about 0.5 Ohm·cm, or about 0.45 Ohm·cm to about 0.5 Ohm·cm. In some embodiments, the graphene dispersion has an average resistivity of about 0.05 Ohm·cm, about 0.10 Ohm·cm, about 0.15 Ohm·cm, about 0.20 Ohm·cm about 0.30 Ohm·cm, about 0.40 Ohm·cm, or about 0.5 Ohm·cm. In some embodiments, the graphene dispersion has an average conductivity of about 1.0 S/cm to about 10.0 S/cm, from about 2.0 S/cm to about 9.0 S/cm, from about 3.0 S/cm to about 8.0 S/cm, from about 4.0 S/cm to about 7.0 S/cm, or about 5.0 S/cm to about 6.0 S/cm. In some embodiments, the graphene dispersion has an average conductivity of about 1.0 S/cm to about 8.0 S/cm, from about 2.0 S/cm to about 9.0 S/cm, or from about 3.0 S/cm to about 10.0 S/cm. In some embodiments, the graphene dispersion has an average conductivity of about 1.0 S/cm, about 1.5 S/cm, about 2.0 S/cm, about 2.5 S/cm, about 3.0 S/cm, about 3.5 S/cm, about 4.0 S/cm, about 4.5 S/cm, about 5.0 S/cm, about 5.5 S/cm, bout 6.0 S/cm, about 6.5 S/cm, about 7.0 S/cm, about 7.5 S/cm, about 8.0 S/cm, about 8.5 S/cm, about 9.0 S/cm, about 9.5 S/cm, or about 10.0 S/cm. In some embodiments, the graphene dispersion comprises a thickness of about 5 μm to about 10 μm, from about 5 μm to about 20 μm, or from about 10 μm to about 20 μm. In some embodiments, the graphene dispersion comprises a plurality of graphene sheets. In some embodiments, the graphene sheets comprise a thickness of about 0.5 nm. In some embodiments, the graphene sheets comprise a thickness of about 2 nm. In some embodiments, the plurality of graphene sheets comprises a thickness of about 10 nm about 8 nm, about 6 nm, about 4 nm, or about 2 nm. In some embodiments, the plurality of graphene sheets comprises from about 1 graphene sheet to about 20 graphene sheets, from about 2 graphene sheets to about 10 graphene sheets, or from about 2 graphene sheets to about 5 graphene sheets. In some embodiments, the plurality of graphene sheets comprises about 10 graphene sheets, about 9 graphene sheets, about 8 graphene sheets, about 7 graphene sheets, about 6 graphene sheets, about 5 graphene sheets, about 4 graphene sheets, about 3 graphene sheets, about 2 graphene sheets, or 1 graphene sheet. In some embodiments, the plurality of graphene sheets comprises up to 13 graphene sheets. In some embodiments, the plurality of graphene sheets is derived from graphite, the graphite having an average diameter of about 10 μm, about 20 μm, about 30 μm, about 50 μm, or about 100 μm. In some embodiments, the plurality of graphene sheets is derived from graphite, the graphite having an average diameter of about 1 μm, about 5 μm, about 10 μm, about 15 μm, or about 20 μm. In some embodiments, the graphene dispersion comprises pores, the pores having an average diameter of about 0.5 μm, about 1.0 μm, about 1.5 μm, about 2.0 μm, about 2.5 μm, or about 3.0 μm. In some embodiments, the graphene dispersion comprises pores of about 0.5 μm to about 3.0 μm. In some embodiments, the graphene dispersion comprises pores of about 0.5 μm to about 1.0 μm, about 0.5 μm to about 1.5 μm, about 0.5 μm to about 2.0 μm, about 0.5 μm to about 2.5 μm, about 0.5 μm to about 3.0 μm, about 1.0 μm to about 1.5 μm, about 1.0 μm to about 2.0 μm, about 1.0 μm to about 2.5 μm, about 1.0 μm to about 3.0 μm, about 1.5 μm to about 2.0 μm, about 1.5 μm to about 2.5 μm, about 1.5 μm to about 3.0 μm, about 2.0 μm to about 2.5 μm, about 2.0 μm to about 3.0 μm, or about 2.5 μm to about 3.0 μm.. In some embodiments, the graphene dispersion has an XRD peak at 2theta of about 26.70 deg. In some embodiments, the graphene dispersion comprises graphene nanosheets. In some embodiments, the graphene nanosheets comprise an average lateral size of about 1 μm. In some embodiments, the graphene nanosheets have an average thickness of 3 nm to 4 nm. In some embodiments, the graphene nanosheets comprise less than 10 layers of graphene. In some embodiments, the graphene nanosheets have an average shelf life of at least about 6 months. In some embodiments, the graphene dispersion comprises graphene nanosheets having an average particle size of at least about 0.1 μm, about 0.5 μm, about 1 μm, about 2 μm, about 3 μm, or about 4 μm. In some embodiments, the graphene dispersion comprises graphene, wherein at least 90% of the graphene has a particle size of less than 10 μm. In some embodiments, the graphene dispersion has an electrical conductivity of at least about 500 S/cm. In some embodiments, the graphene dispersion has an electrical conductivity of about 500 S/cm to about 1,000 S/cm, from about 600 S/cm to about 900 S/cm, or from about 700 S/cm to about 800 S/cm. In some embodiments, the graphene dispersion has an electrical conductivity of about 700 S/cm. In some embodiments, the graphene dispersion has an electrical conductivity of about 500 S/cm to about 1,000 S/cm. In some embodiments, the graphene dispersion has an electrical conductivity of about 500 S/cm to about 600 S/cm, about 500 S/cm to about 700 S/cm, about 500 S/cm to about 800 S/cm, about 500 S/cm to about 900 S/cm, about 500 S/cm to about 1,000 S/cm, about 600 S/cm to about 700 S/cm, about 600 S/cm to about 800 S/cm, about 600 S/cm to about 900 S/cm, about 600 S/cm to about 1,000 S/cm, about 700 S/cm to about 800 S/cm, about 700 S/cm to about 900 S/cm, about 700 S/cm to about 1,000 S/cm, about 800 S/cm to about 900 S/cm, about 800 S/cm to about 1,000 S/cm, or about 900 S/cm to about 1,000 S/cm.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows a first diagram of an exemplary method for recycling battery electrodes from a carbonaceous electrode, per one or more embodiments herein;

FIG. 2 shows a second diagram of an exemplary method for recycling battery electrodes, per one or more embodiments herein;

FIG. 3 shows a third diagram of an exemplary method for recycling battery electrodes, per one or more embodiments herein;

FIG. 4 shows a diagram XRD graph pattern of the precipitate as compared to a standard, per one or more embodiments herein;

FIG. 5A shows a UV-Vis absorption spectra of the first carbonaceous composition, per one or more embodiments herein;

FIG. 5B shows a diagram XRD graph pattern of a film formed of the first material, per one or more embodiments herein;

FIG. 6 shows Raman spectra of the first material, the carbonaceous dispersion, and a film formed with the carbonaceous dispersion, per one or more embodiments herein;

FIG. 7 shows a particle size distribution graph of the carbonaceous dispersion, per one or more embodiments herein;

FIG. 8 shows a Thermogravimetric Analysis (TGA) graph of the carbonaceous dispersion, per one or more embodiments herein;

FIG. 9A shows a first Scanning Electron Microscope (SEM) image of an exemplary carbonaceous dispersion, per one or more embodiments herein;

FIG. 9B shows a second SEM image of an exemplary carbonaceous dispersion, per one or more embodiments herein;

FIG. 10A shows a low magnification Transmission Electron Microscope (TEM) image of an exemplary first material, per one or more embodiments herein;

FIG. 10B shows a medium magnification TEM image of an exemplary first material, per one or more embodiments herein;

FIG. 10C shows a high magnification TEM image of an exemplary first material, per one or more embodiments herein;

FIG. 10D shows a low magnification TEM image of an exemplary carbonaceous dispersion, per one or more embodiments herein;

FIG. 10E shows a medium magnification TEM image of an exemplary carbonaceous dispersion, per one or more embodiments herein;

FIG. 10F shows a high magnification TEM image of an exemplary carbonaceous dispersion, per one or more embodiments herein;

FIG. 11A shows an Atomic Force Microscope (AFM) image of a first exemplary film formed with the carbonaceous dispersion, per one or more embodiments herein;

FIG. 11B shows an AFM image of a second exemplary film formed with the carbonaceous dispersion, per one or more embodiments herein;

FIG. 12A shows an AFM image of a third exemplary film formed with the carbonaceous dispersion, per one or more embodiments herein;

FIG. 12B shows a graph of the cross-sectional heights along the lines of FIG. 12A, per one or more embodiments herein;

FIG. 13 shows a recovered copper foil with no mechanical cracks or damages, per one or more embodiments herein;

FIG. 14 shows recovered lithium ion in the form of lithium carbonate powder in white color, per one or more embodiments herein; and

FIG. 15 shows obtained graphene aqueous dispersion after a storage time of 6 month, per one or more embodiments herein.

### DETAILED DESCRIPTION

While methods to recycle lithium ion and other transition metals (e.g., Fe, Co, Ni, and Mn) from cathodes of lithium-ion batteries (LIBs) have been proposed, such methods are incapable of recycling graphite from recycling of LIB anode materials. Further, the recycling of anode materials, which mainly includes graphite, traditionally a less valuable material, is generally overlooked. While extracted graphite has lower monetary value than the cathode's transitions metals, it is appreciated by the inventors that its exposure to lithium intercalation and deintercalation through multiple charging/discharging cycles permits its further exfoliation to produce valuable, two-dimensional, single-layer, graphene. While graphene is currently formed by chemical oxidation and thermal annealing, which may introduce defects and vacancies to the graphene's basal plane, the exfoliation of graphite into graphene through intercalation and deintercalation can form pristine graphene sheets. The lack of defects provides a beneficial technical effect of outstanding electrical, chemical, and mechanical performance for various applications, for example, including conductive coatings, biomedical sensors, and structural composites.

As such, provided herein are methods for processing carbonaceous compositions, for example, to exfoliate carbonaceous compositions with graphite intercalation compounds into graphene. In some embodiments, the methods herein react graphite in an anode, a cathode, or both, with an alkali metal (e.g., potassium and sodium/potassium alloys) to form a graphite intercalation compound, which is sonicated in a solvent to yield a dispersion of carbon nanoparticles (e.g., nanoscrolls and nanoplatelets). For instance, graphite anodes from lithium-ion batteries that are charged before recycling, show higher degrees of intercalation by lithium ions. Together with recovery of other components in the anode, such as for example, copper foil and lithium, the methods herein solve a technical problem of recovering and/or recycling anode materials from spent LIBs into commercially useful products which can be reused in further applications, and which provide sustainable value.

### Methods for Recycling Battery Materials

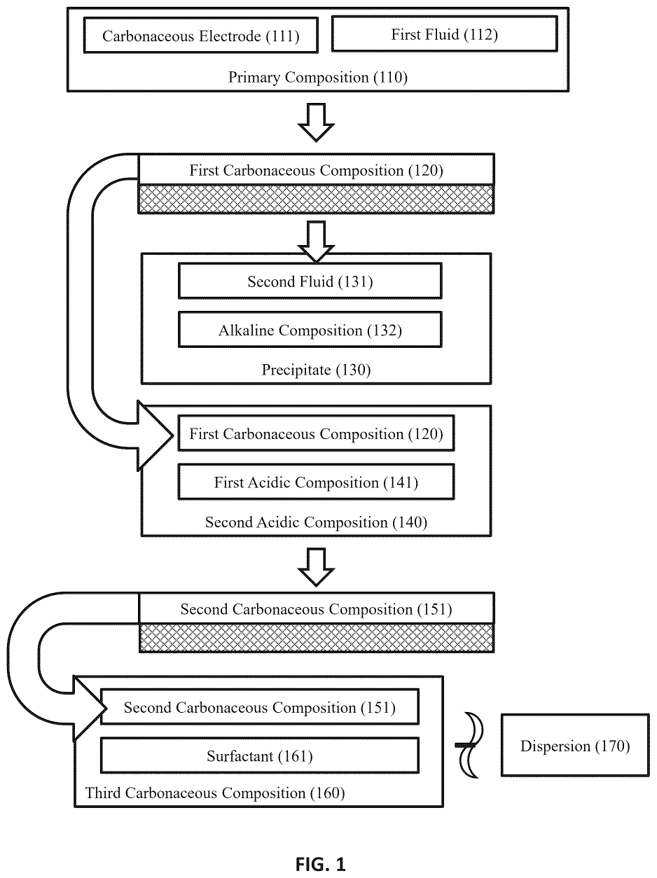

In one aspect, disclosed herein, per FIG. 1, is a method for recycling battery materials. In some embodiments, the method comprises disposing a carbonaceous electrodes 111 in a first fluid 112, to form a primary composition 110, separating a first carbonaceous composition 120 from a second fluid 131 from the primary composition 110, mixing the second fluid 131 with an alkaline composition 132 to form a precipitate 130, combining the first carbonaceous composition 120 with a first acidic composition 141 to form a second acidic composition 140, filtering the second acidic composition 140 to form a second carbonaceous composition 151, combining a surfactant 161 with the second carbonaceous composition 151 to form a third carbonaceous composition 160, and shearing the third carbonaceous composition 160 to form a dispersion 170.

In some embodiments, the carbonaceous electrode 111 comprises graphite. In some embodiments, the carbonaceous electrode 111 is an anode or negative active material. In some embodiments, the first carbonaceous composition 120 comprises a carbonaceous material collected from a portion of one or more carbonaceous electrodes 111. In some embodiments, combining the first carbonaceous composition 120 with a first acidic composition 141 is configured to produce the graphene dispersion 170 with an increased volume of graphene sheets as compared to an absence of the first acidic composition 141. In some embodiments, the dispersion 170 comprises graphene.

In some embodiments, the method further comprises separating the dispersion 170 to obtain a fourth carbonaceous composition and a residual composition, the fourth carbonaceous composition comprising graphene. In some embodiments, the method further comprises repeating the combining, the filtering, the shearing, and the separating steps.

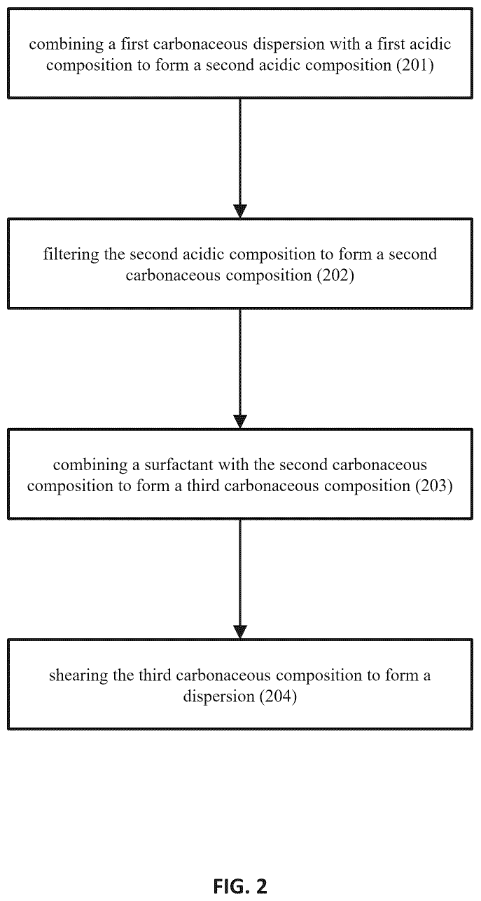

Another aspect provided herein, per FIG. 2, is a method for recycling battery materials. As shown, the method comprises combining a first carbonaceous material with an acid to form a first carbonaceous composition 201; filtering the first carbonaceous composition to form a filtrate 202; combining a surfactant with the filtrate to form a second carbonaceous composition 203; and shearing the second carbonaceous composition to form a dispersion 204.

However, the selection of a suitable surfactant and shearing conditions which is suitable to form high quality graphene suitable for use electronics and other high value applications remains a challenge, as not all surfactants can successfully convert graphite in carbonaceous compositions into high quality graphene, much less high-quality graphene which forms a stable graphene dispersion, including high quality graphene which forms a stable graphene dispersion for at least 6 months. In some embodiments, shearing the second carbonaceous composition comprises shearing the second carbonaceous composition at a rate of about 6,000 revolutions per minute (rpm) to about 12,000 rpm. combining the surfactant with the second carbonaceous composition comprises adding the surfactant to a final concentration (% w/w) of about 0.05 wt % to about 10 wt %. In some embodiments, the methods herein provide a beneficial technical effect of enabling the efficient extraction of a highly exfoliated materials from spent anodes. In some embodiments, the first fluid, the second fluid, or both comprises water, ethanol, or both. In some embodiments, the surfactant comprises an ionic surfactant, an aromatic ionic surfactant, an aromatic non-ionic surfactant, a non-aromatic surfactant, an ionic liquid, a polymeric surfactant, or any combination thereof. In some embodiments, the ionic surfactant comprises a hydrocarbon-based ionic surfactant. In some embodiments, the surfactant is present at a concentration of about 0.5 mM to about 5 mM. In some embodiments, the surfactant is present at a concentration above the critical micelle concentration of the surfactant. In some embodiments, the surfactant comprises sodium cholate (SC), sodium dodecyl sulfate (SDS), sodium lauryl sulfate (SLS), sodium dodecylbenzene sulfonate (SDBS), sodium dihexyl sulfosuccinate (SDSS), sodium deoxycholate, sodium taurodeoxycholate (STDC), dodecyltrimethyl ammonium bromide (DTAB), tetradecyltrimethyl ammonium bromide (TTAB), cetyltrimethyl ammonium bromide (CTAB), Triton X-100, IGEPAL CO-890, arachidic acid, nanocellulose, or any combination thereof. In some embodiments, the surfactant comprises sodium cholate. In some embodiments, the surfactant comprises an aromatic surfactant, the aromatic surfactant comprising 1-pyrene sulfonic acid sodium salt. In some embodiments, the surfactant comprises an aromatic non-ionic surfactant, the aromatic non-ionic surfactant comprising porphyrins, porphycene, corrphycene, hemiporphycene, isoporphycene, or any combination thereof. In some embodiments, the surfactant comprises a non-aromatic surfactant, the non-aromatic surfactant comprising SDS. In some embodiments, the surfactant comprises an ionic liquid, the ionic liquid comprising 1-hexyl-3-methyl imidazolium hexafluorophosphate (HMIM). In some embodiments, the surfactant comprises a polymeric surfactant, the polymeric surfactant comprising polyvinylpyrrolidone (PVP), polyethylene glycol (PEG), acrylate, acrylamide, cetrimonium bromide, cetylpyridinium chloride, dimethyloctadecylammonium chloride, or any combination thereof. In some embodiments, the surfactant comprises an aromatic surfactant. In some embodiments, the aromatic surfactant comprises sodium cholate. In some embodiments, the surfactant comprises a non-aromatic surfactant. In some embodiments, the surfactant comprises sodium cholate (SC). In some embodiments, the aromatic surfactant comprises sodium dodecyl sulfate (SDS). In some embodiments, the surfactant comprises an ionic surfactant. In some embodiments, the ionic surfactant comprises sodium cholate, SDS, or both. In some embodiments, the surfactant comprises a non-ionic surfactant. In some embodiments, the specific fluids, acids, and surfactants herein provide a beneficial technical effect of enabling the efficient extraction of a highly exfoliated materials from spent anodes. In some embodiments, the surfactants and their concentrations herein decreases a viscosity of the second carbonaceous composition. In some embodiments, the surfactants and their concentrations herein promotes dispersion of the second carbonaceous composition. In some embodiments, the surfactants and their concentrations herein promotes the formation of high-quality graphene suitable for use electronics and other high value applications from graphite in carbonaceous compositions. In some embodiments, the surfactants and their concentrations herein promotes exfoliation of graphite into graphene.

In some embodiments, separating the first fluid comprises removing lithium. In some embodiments, separating the second carbonaceous composition to obtain a carbonaceous dispersion comprises centrifuging the second carbonaceous composition to pellet the carbonaceous dispersion. In some embodiments, centrifuging the second carbonaceous composition is performed at a speed of about 1,000 rpm to about 3,000 rpm. In some embodiments, centrifuging the second carbonaceous composition is performed for a time of about 5 minutes to about 30 minutes. In some embodiments, the graphite powder is derived from a charged graphite anode or a discharged graphite anode.

In some embodiments, centrifuging the second carbonaceous composition is performed at a speed of about 1,000 rpm to about 3,000 rpm. In some embodiments, centrifuging the second carbonaceous composition is performed at a speed of about 1,000 rpm to about 1,200 rpm, about 1,000 rpm to about 1,400 rpm, about 1,000 rpm to about 1,600 rpm, about 1,000 rpm to about 1,800 rpm, about 1,000 rpm to about 2,000 rpm, about 1,000 rpm to about 2,200 rpm, about 1,000 rpm to about 2,400 rpm, about 1,000 rpm to about 2,600 rpm, about 1,000 rpm to about 2,800 rpm, about 1,000 rpm to about 3,000 rpm, about 1,200 rpm to about 1,400 rpm, about 1,200 rpm to about 1,600 rpm, about 1,200 rpm to about 1,800 rpm, about 1,200 rpm to about 2,000 rpm, about 1,200 rpm to about 2,200 rpm, about 1,200 rpm to about 2,400 rpm, about 1,200 rpm to about 2,600 rpm, about 1,200 rpm to about 2,800 rpm, about 1,200 rpm to about 3,000 rpm, about 1,400 rpm to about 1,600 rpm, about 1,400 rpm to about 1,800 rpm, about 1,400 rpm to about 2,000 rpm, about 1,400 rpm to about 2,200 rpm, about 1,400 rpm to about 2,400 rpm, about 1,400 rpm to about 2,600 rpm, about 1,400 rpm to about 2,800 rpm, about 1,400 rpm to about 3,000 rpm, about 1,600 rpm to about 1,800 rpm, about 1,600 rpm to about 2,000 rpm, about 1,600 rpm to about 2,200 rpm, about 1,600 rpm to about 2,400 rpm, about 1,600 rpm to about 2,600 rpm, about 1,600 rpm to about 2,800 rpm, about 1,600 rpm to about 3,000 rpm, about 1,800 rpm to about 2,000 rpm, about 1,800 rpm to about 2,200 rpm, about 1,800 rpm to about 2,400 rpm, about 1,800 rpm to about 2,600 rpm, about 1,800 rpm to about 2,800 rpm, about 1,800 rpm to about 3,000 rpm, about 2,000 rpm to about 2,200 rpm, about 2,000 rpm to about 2,400 rpm, about 2,000 rpm to about 2,600 rpm, about 2,000 rpm to about 2,800 rpm, about 2,000 rpm to about 3,000 rpm, about 2,200 rpm to about 2,400 rpm, about 2,200 rpm to about 2,600 rpm, about 2,200 rpm to about 2,800 rpm, about 2,200 rpm to about 3,000 rpm, about 2,400 rpm to about 2,600 rpm, about 2,400 rpm to about 2,800 rpm, about 2,400 rpm to about 3,000 rpm, about 2,600 rpm to about 2,800 rpm, about 2,600 rpm to about 3,000 rpm, or about 2,800 rpm to about 3,000 rpm.

In some embodiments, centrifuging the second carbonaceous composition is performed for a time of about 5 minutes to about 30 minutes. In some embodiments, centrifuging the second carbonaceous composition is performed for a time of about 5 minutes to about 10 minutes, about 5 minutes to about 15 minutes, about 5 minutes to about 20 minutes, about 5 minutes to about 25 minutes, about 5 minutes to about 30 minutes, about 10 minutes to about 15 minutes, about 10 minutes to about 20 minutes, about 10 minutes to about 25 minutes, about 10 minutes to about 30 minutes, about 15 minutes to about 20 minutes, about 15 minutes to about 25 minutes, about 15 minutes to about 30 minutes, about 20 minutes to about 25 minutes, about 20 minutes to about 30 minutes, or about 25 minutes to about 30 minutes. In some embodiments, centrifuging the second carbonaceous composition is performed for a time of about 5 minutes, about 10 minutes, about 15 minutes, about 20 minutes, about 25 minutes, or about 30 minutes.

In some embodiments, the method further comprises disposing a carbonaceous electrodes in a first fluid to form a composition. In some embodiments, the method includes recovering a current collector from the one or more carbonaceous electrodes. In some embodiments, recovering the current collector comprises recovering the current collector from the first fluid. In some embodiments, recovering the current collector comprises recovering the current collector with no mechanical cracks or damage. In some embodiments, the current collector comprises copper (Cu). In some embodiments, the carbonaceous electrode comprises graphite. In some embodiments, the method further comprises separating a solution comprising lithium or lithium ions from the composition. In some embodiments, the method further comprises combining the solution comprising lithium or lithium ions with an alkaline composition, the alkaline composition optionally comprising a carbonate, to form a precipitate.

In some embodiments, the method further comprises heating the composition to a temperature of about 50° C. to about 90° C. In some embodiments, the method further comprises: filtering the precipitate from a supernatant; collecting the supernatant; and combining the supernatant with a salt solution to produce an alkaline composition, the alkaline composition optionally comprising a carbonate, salt, the salt solution comprising an alkaline composition, the alkaline composition optionally comprising a carbonate. In some embodiments, the supernatant comprises lithium. In some embodiments, the carbonate comprises sodium carbonate. In some embodiments, the method further comprises heating the first carbonaceous composition to a temperature of at least about 10° C., 15° C., 20° C., 25° C., 30° C., or more, including increments therein.

In some embodiments, the method further comprises separating the second carbonaceous composition to form a carbonaceous dispersion. In some embodiments, the carbonaceous dispersion comprises graphite. In some embodiments, the method further comprises mixing the fourth carbonaceous material with the acidic composition. In some embodiments, the mixing, heating, and cooling procedures herein provide a beneficial technical effect of imparting sufficient shearing forces for efficient extraction of a highly exfoliated materials from spent anodes.

In some embodiments, the filtrate has a pH of less than about 3, 2.5, 2, 1.5, 1, 0.5 or less, including increments therein. In some embodiments, the first acid comprises sulfuric acid, hydrochloric acid, perchloric acid, or any combination thereof. In some embodiments, a ratio of the first acid to the first carbonaceous material is about 20:1 to about 200:1. In some embodiments, the ratio of the first acid to the first carbonaceous material is about 10:1 to about 100:1. In some embodiments, a ratio of the first acid to the first carbonaceous material is about 10:1 to about 200:1. In some embodiments, a ratio of the first acid to the first carbonaceous material is about 10:1 to about 20:1, about 10:1 to about 30:1, about 10:1 to about 40:1, about 10:1 to about 50:1, about 10:1 to about 60:1, about 10:1 to about 70:1, about 10:1 to about 80:1, about 10:1 to about 90:1, about 10:1 to about 100:1, about 10:1 to about 150:1, about 10:1 to about 200:1, about 20:1 to about 30:1, about 20:1 to about 40:1, about 20:1 to about 50:1, about 20:1 to about 60:1, about 20:1 to about 70:1, about 20:1 to about 80:1, about 20:1 to about 90:1, about 20:1 to about 100:1, about 20:1 to about 150:1, about 20:1 to about 200:1, about 30:1 to about 40:1, about 30:1 to about 50:1, about 30:1 to about 60:1, about 30:1 to about 70:1, about 30:1 to about 80:1, about 30:1 to about 90:1, about 30:1 to about 100:1, about 30:1 to about 150:1, about 30:1 to about 200:1, about 40:1 to about 50:1, about 40:1 to about 60:1, about 40:1 to about 70:1, about 40:1 to about 80:1, about 40:1 to about 90:1, about 40:1 to about 100:1, about 40:1 to about 150:1, about 40:1 to about 200:1, about 50:1 to about 60:1, about 50:1 to about 70:1, about 50:1 to about 80:1, about 50:1 to about 90:1, about 50:1 to about 100:1, about 50:1 to about 150:1, about 50:1 to about 200:1, about 60:1 to about 70:1, about 60:1 to about 80:1, about 60:1 to about 90:1, about 60:1 to about 100:1, about 60:1 to about 150:1, about 60:1 to about 200:1, about 70:1 to about 80:1, about 70:1 to about 90:1, about 70:1 to about 100:1, about 70:1 to about 150:1, about 70:1 to about 200:1, about 80:1 to about 90:1, about 80:1 to about 100:1, about 80:1 to about 150:1, about 80:1 to about 210000:1, about 90:1 to about 100:1, about 90:1 to about 150:1, about 90:1 to about 200:1, about 100:1 to about 150:1, about 100:1 to about 200:1, or about 150:1 to about 200:1.

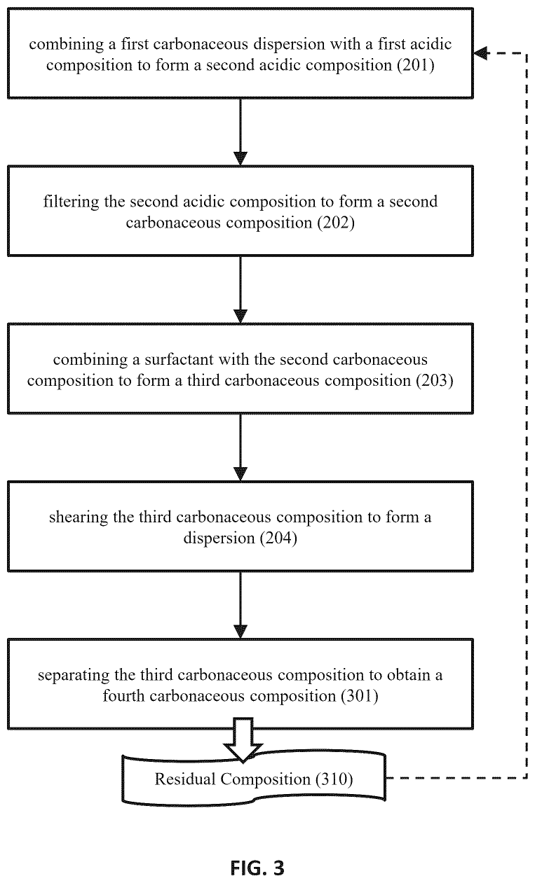

Another aspect provided herein, per FIG. 3, is a method for recycling battery materials. As shown, the method comprises (a) combining a first carbonaceous material with an acid to form a first carbonaceous composition 201; (b) filtering the first carbonaceous composition to form a filtrate 202; (c) combining a surfactant with the filtrate to form a second carbonaceous composition 203; (d) shearing the second carbonaceous composition to form a dispersion 204, (e) separating the second carbonaceous composition to obtain a carbonaceous dispersion 301, and repeating steps (a) to (e) using a residual composition 310 in place of the first carbonaceous material.

In some embodiments, the method further comprises disposing the carbonaceous electrodes in a first fluid, the carbonaceous electrode comprising graphite, to form a primary composition; separating the first fluid from the primary composition; and mixing the first fluid with an alkaline composition, the alkaline composition optionally comprising a carbonate, to form a precipitate.

In some embodiments, shearing the second carbonaceous composition comprises shearing the second carbonaceous composition at a rate of at about 6,000 revolutions per minute (rpm) to about 12,000 rpm. In some embodiments, shearing the second carbonaceous composition comprises shearing the second carbonaceous composition for at least two hours, at least three hours, at least four hours, or at least five hours.

In some embodiments, separating the second carbonaceous composition to obtain a carbonaceous dispersion comprises centrifuging the second carbonaceous composition. In some embodiments, centrifuging the second carbonaceous composition is performed at a speed of about 1,000 rpm to about 3,000 rpm. In some embodiments, centrifuging the second carbonaceous composition is performed for a time of about 5 minutes to about 30 minutes.

In some embodiments, the method further comprises washing the filtrate with water after filtering the first carbonaceous composition. In some embodiments, the method further comprises drying the filtrate at a temperature of at least about 50° C., about 60° C., about 70° C., about 80° C., or about 90° C. In some embodiments, the mixing, heating, and cooling procedures herein provide a beneficial technical effect of imparting sufficient shearing forces for efficient extraction of a highly exfoliated materials from spent anodes.

In some embodiments, combining the surfactant with the second carbonaceous composition comprises adding the surfactant to a final concentration (% w/w) of about 0.05% to about 10%. In some embodiments, the surfactant comprises a hydrocarbon-based ionic surfactant, an aromatic ionic surfactant, an aromatic non-ionic surfactant, a non-aromatic surfactant, an ionic liquid, a polymeric surfactant, or any combination thereof. In some embodiments, the hydrocarbon-based ionic surfactant comprises a C1-C8 hydrocarbon, a C9-C14 hydrocarbon, or C16-C35 hydrocarbon. In some embodiments, the surfactant comprises an aromatic surfactant, the aromatic surfactant comprising 1-pyrene sulfonic acid sodium salt. In some embodiments, the surfactant comprises an aromatic non-ionic surfactant, the aromatic non-ionic surfactant comprising porphyrins, porphycene, corrphycene, hemiporphycene, isoporphycene, or any combination thereof. In some embodiments, the surfactant comprises a non-aromatic surfactant, the non-aromatic surfactant comprising SDS. In some embodiments, the surfactant comprises an ionic liquid, the ionic liquid comprising 1-hexyl-3-methyl imidazolium hexafluorophosphate (HMIM). In some embodiments, the surfactant comprises a polymeric surfactant, the polymeric surfactant comprising polyvinylpyrrolidone (PVP), polyethylene glycol (PEG), acrylate, acrylamide, cetrimonium bromide, cetylpyridinium chloride, dimethyloctadecylammonium chloride, or any combination thereof. In some embodiments, the surfactant is present at a concentration of at least about 0.5 mM, 1 mM, 1.5 mM, 2 mM, 2.5 mM, 3 mM, or more, including increments therein. In some embodiments, adding a surfactant comprises adding sodium cholate (SC), sodium dodecyl sulfate (SDS), sodium lauryl sulfate (SLS), myristic acid, palmitic acid, stearic acid, sodium dodecylbenzene sulfonate (SDBS), sodium dihexyl sulfosuccinate (SDSS), sodium deoxycholate, sodium taurodeoxycholate (STDC), dodecyltrimethyl ammonium bromide (DTAB), tetradecyltrimethyl ammonium bromide (TTAB), cetyltrimethyl ammonium bromide (CTAB), Triton X-100, IGEPAL CO-890, arachidic acid, nanocellulose, or any combination thereof.

In some embodiments, separating the first fluid comprises separating lithium. In some embodiments, the method further comprises mixing the fourth carbonaceous material with the acidic composition. In some embodiments, the method further comprises heating the primary composition to a temperature of about 50° C. to about 90° C.

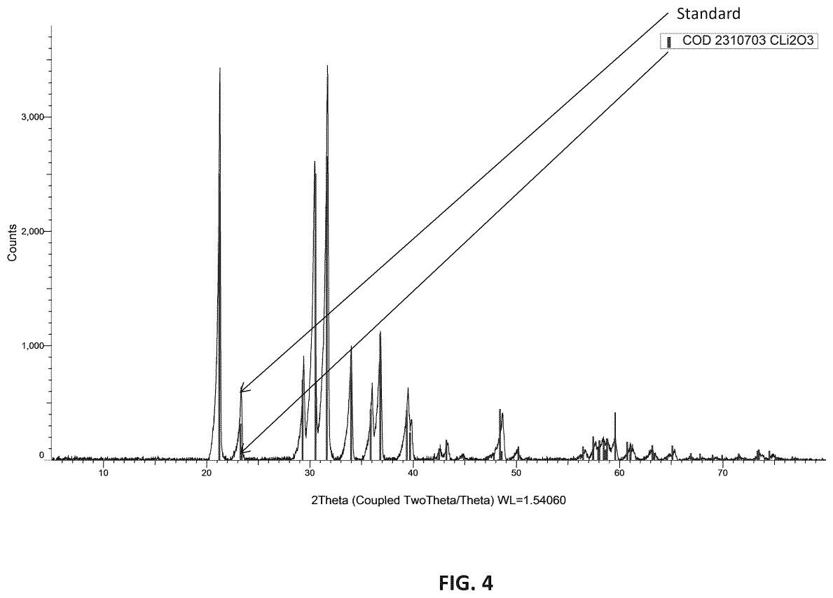

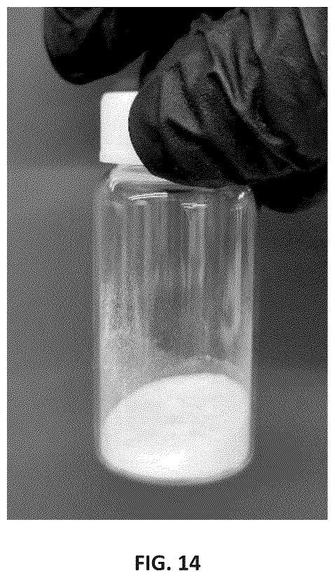

In some embodiments, the method further comprises filtering the precipitate to form a solid; collecting a supernatant, the supernatant comprising lithium; and mixing the supernatant in a salt solution, the salt solution comprising an alkaline composition, the alkaline composition optionally comprising a carbonate, to produce an alkaline composition, the alkaline composition optionally comprising a carbonate, powder. In some embodiments, the method further comprises heating the first carbonaceous composition to a temperature of at least about 10° C., 15° C., 20° C., 25° C., 30° C., or more, including increments therein. In some embodiments, the first acid has a pH of less than about 3, 2.5, 2, 1.5, 1, or less, including increments therein. In some embodiments, the carbonate powder is lithium carbonate. In some embodiments, the carbonate powder is lithium carbonate, as is illustrated in FIG. 14. In some embodiments, the mixing procedures herein provide a beneficial technical effect of imparting sufficient shearing forces for efficient extraction of a highly exfoliated materials from spent anodes. As is shown in FIG. 4, the obtained precipitate is lithium carbonate, with an X-ray diffraction (XRD) pattern of the obtained lithium carbonate precipitate being shown in comparison to a lithium carbonate standard, showing a substantially identical match.

Another aspect provided herein is a method comprising: (a) disposing the carbonaceous electrodes in a first fluid, the carbonaceous electrode comprising graphite, to form a primary composition; (b) separating a first carbonaceous material from the first fluid from the primary composition; (c) mixing the first fluid with an alkaline composition, the alkaline composition optionally comprising a carbonate, to form a precipitate; (d) combining the first carbonaceous material with an acid to form a first carbonaceous composition, the first carbonaceous material comprising carbonaceous material collected from a portion of a carbonaceous electrode; (e) filtering the first carbonaceous composition to form a filtrate; (f) combining a surfactant with the filtrate to form a second carbonaceous composition; (g) shearing the second carbonaceous composition; (h) separating the dispersion to obtain a carbonaceous dispersion and a residual composition, the carbonaceous dispersion comprising graphene; (i) and repeating steps (a) to (h). In some embodiments, combining the first carbonaceous material with an acid is configured to produce a graphene dispersion, the graphene dispersion having an increased volume of graphene sheets as compared to an absence of the first acid. In some embodiments, the mixing procedures herein provide a beneficial technical effect of imparting sufficient shearing forces for efficient extraction of a highly exfoliated materials from spent anodes.

### Graphene Dispersions

Another aspect provided herein is a graphene dispersion formed utilizing the methods described herein. In some cases, the graphene dispersion formed from a recycled graphite anode the graphene dispersion comprising graphene, wherein the graphene is remains suspended in solution for at least 6 months. In some embodiments, the graphene dispersion has a D/G ratio of less than about 1.0. In some embodiments, the graphene dispersion has a D/G of less than about 0.5.

In some embodiments, the graphene dispersion comprises an oxygen content from about 1 wt % to about 8 wt %. In some embodiments, the graphene dispersion comprises an oxygen content from about 1 wt % to about 2 wt %, about 1 wt % to about 3 wt %, about 1 wt % to about 4 wt %, about 1 wt % to about 5 wt %, about 1 wt % to about 6 wt %, about 1 wt % to about 7 wt %, about 1 wt % to about 8 wt %, about 2 wt % to about 3 wt %, about 2 wt % to about 4 wt %, about 2 wt % to about 5 wt %, about 2 wt % to about 6 wt %, about 2 wt % to about 7 wt %, about 2 wt % to about 8 wt %, about 3 wt % to about 4 wt %, about 3 wt % to about 5 wt %, about 3 wt % to about 6 wt %, about 3 wt % to about 7 wt %, about 3 wt % to about 8 wt %, about 4 wt % to about 5 wt %, about 4 wt % to about 6 wt %, about 4 wt % to about 7 wt %, about 4 wt % to about 8 wt %, about 5 wt % to about 6 wt %, about 5 wt % to about 7 wt %, about 5 wt % to about 8 wt %, about 6 wt % to about 7 wt %, about 6 wt % to about 8 wt %, or about 7 wt % to about 8 wt %. In some embodiments, the graphene dispersion comprises a nitrogen content from about 0.1 wt % to about 5 wt %. In some embodiments, the graphene dispersion comprises a nitrogen content from about 0.1 wt % to about 5 wt %. In some embodiments, the graphene dispersion comprises a nitrogen content from about 0.1 wt % to about 1 wt %, about 0.1 wt % to about 2 wt %, about 0.1 wt % to about 3 wt %, about 0.1 wt % to about 4 wt %, about 0.1 wt % to about 5 wt %, about 1 wt % to about 2 wt %, about 1 wt % to about 3 wt %, about 1 wt % to about 4 wt %, about 1 wt % to about 5 wt %, about 2 wt % to about 3 wt %, about 2 wt % to about 4 wt %, about 2 wt % to about 5 wt %, about 3 wt % to about 4 wt %, about 3 wt % to about 5 wt %, or about 4 wt % to about 5 wt %. In some embodiments, the graphene dispersion comprises a carbon content from about 75% to about 99%. In some embodiments, the graphene dispersion comprises carbon and oxygen in a ratio of about 10:1 by weight to about 50:1 by weight.

In some embodiments, the graphene dispersion has a thermal conductivity of about 0.5 W/mK to about 2.0 W/mK. In some embodiments, the graphene dispersion has a thermal conductivity of about 1.0 W/mK to about 2.0 W/mK. In some embodiments, the graphene dispersion has a thermal diffusivity of about 1 mm²/s to about 5 mm²/s. In some embodiments, the graphene dispersion has a specific heat of about 0.3 MJ/m³K to about 0.7 MJ/m³K. In some embodiments, the graphene dispersion has an average sheet resistance of about 80 Ohm/sq to about 180 Ohm/sq. In some embodiments, the graphene dispersion has an average resistivity of about 0.05 Ohm·cm to about 0.50 Ohm·cm. In some embodiments, the graphene dispersion has an average conductivity of about 1.0 S/cm to about 10.0 S/cm.

In some embodiments, the graphene dispersion comprises a plurality of graphene sheets. In some embodiments, the graphene in the graphene dispersion has a thickness of about 5 μm to about 20 μm. In some embodiments, the graphene sheets have a thickness of about 0.5 nm. In some embodiments, the graphene sheets have a thickness of about 2 nm. In some embodiments, the plurality of graphene sheets comprises from about 1 graphene sheet to about 20 graphene sheets

In some embodiments, the graphene dispersion comprises graphene nanosheets. In some embodiments, the graphene nanosheets comprise an average lateral size of at least about 0.5 μm, 1 μm, 2 μm, 3 μm, 4 μm, 5 μm, or more μm. In some embodiments, the graphene nanosheets have an average thickness of 3 nm to 4 nm. In some embodiments, the graphene dispersion comprises graphene nanosheets having an average particle size of at least about 0.1 μm, about 0.5 μm, about 1 μm, about 2 μm, about 3 μm, about 4 μm, about 5 μm, about 6 μm, about 7 μm, about 8 μm, about 9 μm, about 10 μm, or more μm. In some embodiments, the graphene dispersion comprises a plurality of graphene, wherein at least 70%, 80%, 90%, or 95% of the graphene has a particle size of less than 10 μm, 9 μm, 8 μm, 7 μm, 6 μm, 5 μm, 4 μm, 3 μm, 2 μm, 1 μm, or less μm. In some embodiments, the plurality of graphene in the plurality of graphene comprises nanosheets, nanoscrolls, nanoplatelets, or any combination thereof. In some embodiments, the graphene nanosheets comprise less than 10, 9, 8, 7, 6, or 5 layers of graphene. In some embodiments, the graphene nanosheets have an average shelf life of at least about 1, 2, 3, 4, 5, 6, 7, 8, 9, 10, 11, 12, or more months.

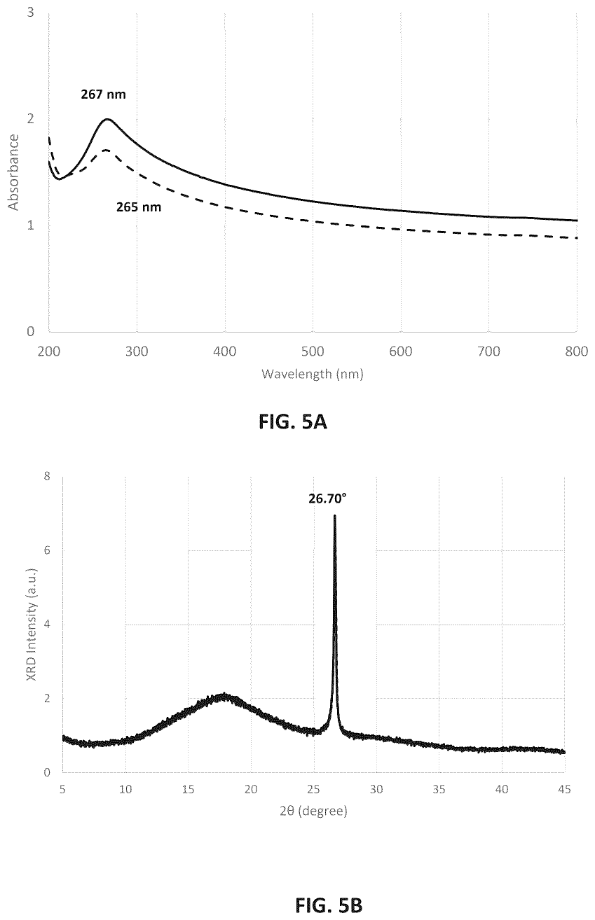

In some embodiments, per FIG. 5B, the graphene dispersion has an XRD peak at 2theta of about 26.70 deg. The characteristic graphene peaks at around 265-268 nm in the UV-Vis absorption spectra shows that thin graphene nanosheets are stably and uniformly dispersed in the aqueous solution. FIG. 5A show UV-Vis absorption spectra and an XRD pattern of the obtained graphene dispersion. Without acid washing (solid) the spectra has a peak at about 257 nm, wherein with acid washing (dashed) the spectra has a peak at about 265 nm.

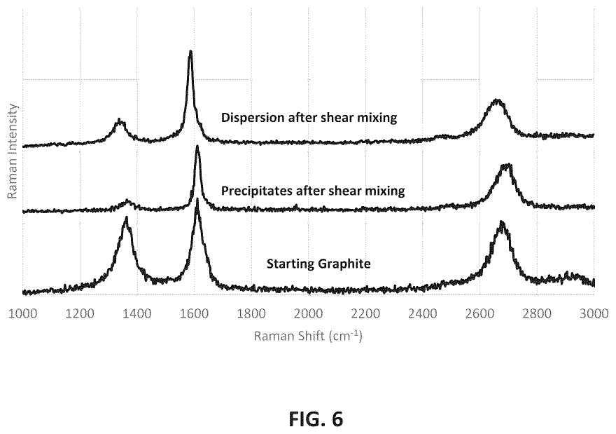

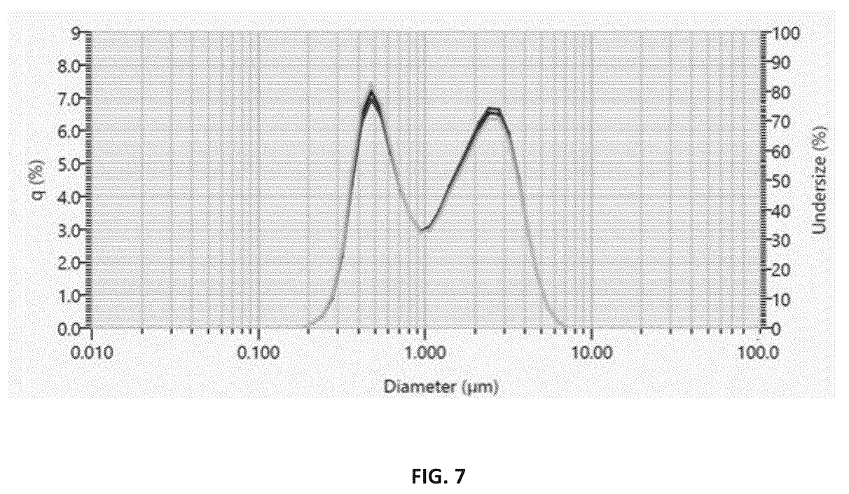

FIG. 6 shows Raman spectra of the recovered graphite (bottom), precipitated graphite after shear mixing (middle curve), and filtered graphene film from the shear mixed graphene dispersion (top). FIG. 7 shows a particle distribution graph of exemplary graphene nanosheets exhibiting a D10 of 0.40 μm, D50 of 1.27 μm, and D90 of 3.38 μm.

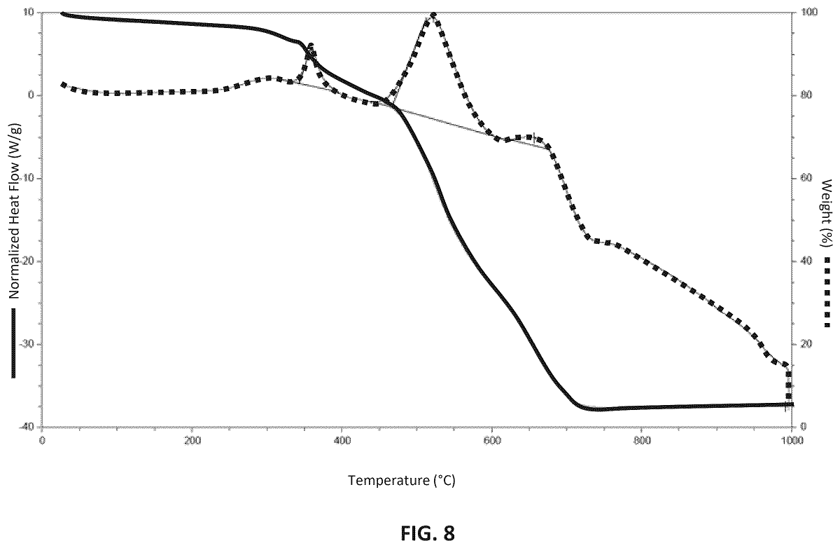

FIG. 8 shows a Thermogravimetric Analysis (TGA) graph of the carbonaceous dispersion, wherein the heat flow has a first peak temperature at about 360° C., a second peak temperature of about 522° C., and a third peak temperature of about 657° C. Further, the weight percentage shown therein has a residue of about 0.11 mg and 5%.

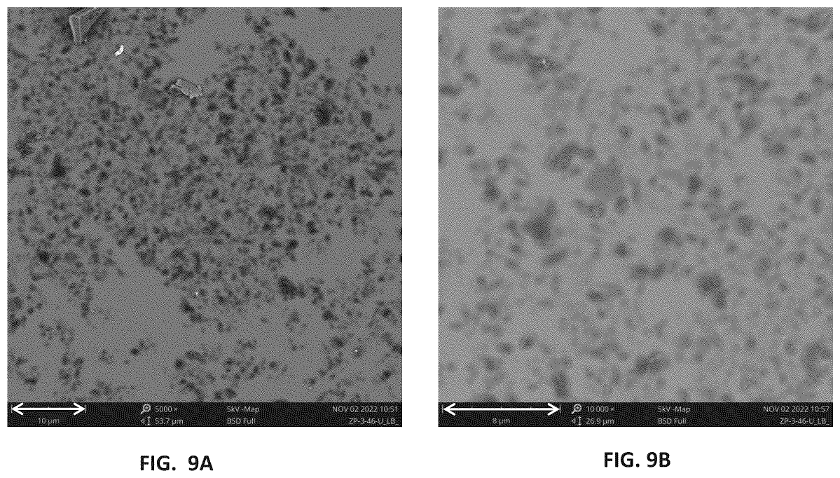

FIGS. 9A-9B show 5,000× and 10,000× scanning Electron Microscope (SEM) images, respectively, of an exemplary carbonaceous dispersion. The arrows shown therein represent 10 μm and 8 μm scales, respectively. As shown, the graphene nanosheets have an average lateral size of about 1 μm, which is in agreement with the previous particle size measurement of FIG. 7.

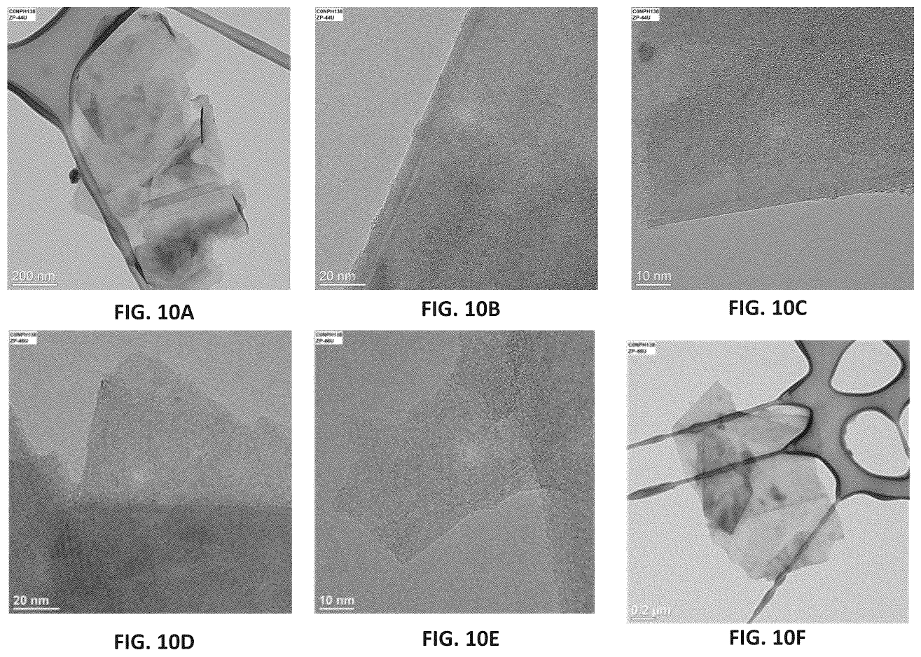

FIGS. 10A, 10B, and 10C show low, medium, and high magnification Transmission Electron Microscope (TEM) image of an exemplary first material, with scale bars denoting 200 μm, 20 μm, and 10 μm, respectively. FIGS. 10D, 10E, and 10F show low, medium, and high magnification Transmission Electron Microscope (TEM) image of an exemplary first material, with scale bars denoting 20 μm, 10 μm, and 0.2 μm, respectively. As shown therein, the number of graphene layers is about 5-10, which confirms the successful exfoliation from spent anode materials.

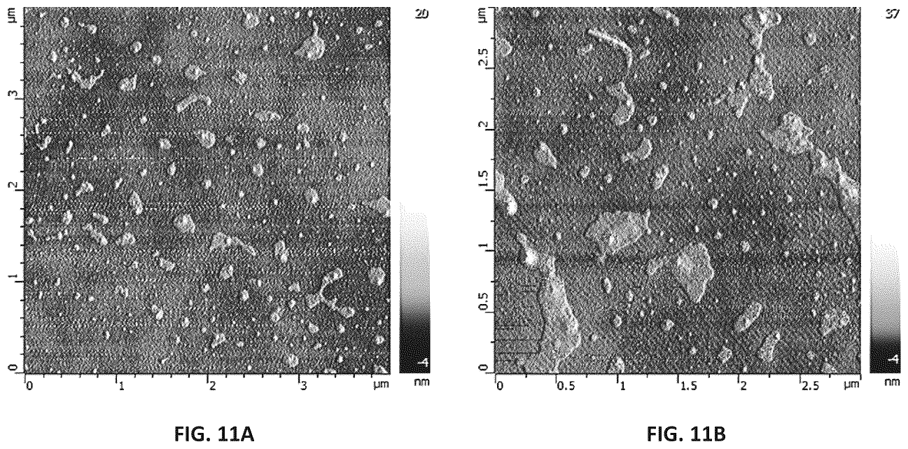

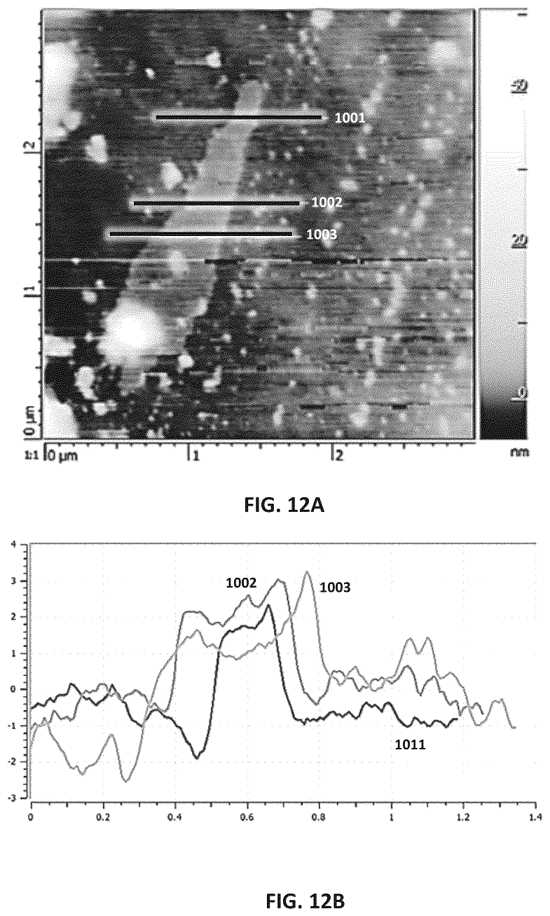

FIGS. 11A, 11B, and 12A show an Atomic Force Microscope (AFM) images of exemplary films formed with the carbonaceous dispersion. FIG. 12B shows a graph of the cross-sectional heights along the lines of FIG. 12A. As shown therein, the carbonaceous dispersion has an average thickness of about 3 nm to about 4 nm, corresponding to about 13 graphene layers, further confirming the successful exfoliation from spent anode materials. All exemplary films shown herein were casted on a silicon wafer by Langmuir-Blodgett technique and dried.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount. In some cases, the term “about” refers to an amount that is near the stated amount by 15%, 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

### EXAMPLES

The following illustrative example is representative of embodiments of the methods described herein and are not meant to be limiting in any way.

### Example 1

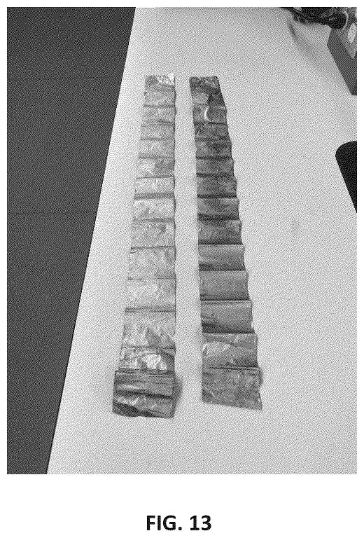

In one example, the anode is removed from a charged or discharged battery in a pouch and stored in a thermal insulating chamber. The anode is placed in water, where, after a violent bubbling reaction between the anode's lithium-graphite intercalation compound, the copper foil current collector can be easily separated from the aqueous dispersion of graphite. The recovered copper foil (FIG. 13) maintains its structural integrity and can be reused as the anode current collector in new LIBs after minor surface cleaning and purification.

The aqueous dispersion of graphite is then filtered to separate the graphite solid from a lithium-ion solution. The solution is heated to 70° C. and sodium carbonate is added to form a white precipitate comprising lithium carbonate. Filtering the lithium carbonate precipitate, cleaning with DI water, and drying at 80° C. in an oven forms a lithium carbonate powder. In one example, 1.1223 g of lithium carbonate were extracted from a charged cell, and 0.3074 g of lithium carbonate were extracted from a discharged cell.

The graphite solid is washed and dried at 80° C. in an oven. In one example, 6.1337 g of graphite were extracted from a charged cell, and 6.0888 g of graphite were extracted from a discharged cell.

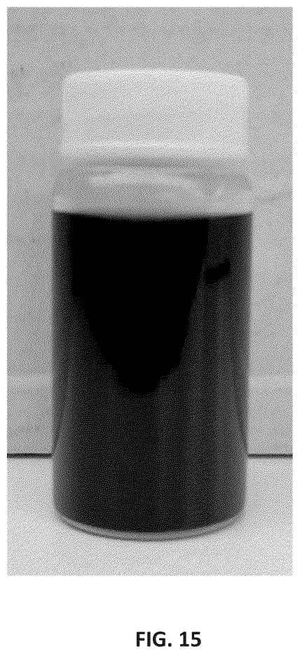

The graphite solid can be reused to form new LIB anodes. Alternatively, the graphite solid can be processed into a graphene dispersion by washing the graphite powder in sulfuric acid at 40° C. for 4 hours, filtering the graphene dispersion from the graphite solid, washing the graphene dispersion with DI water and drying it at 80° C. in an oven. The graphite powder may be shear mixed in an aqueous solution of 3 mM sodium cholate (SC) or sodium dodecyl sulfate (SDS) at a speed of 10,000 rpm to 12,000 rpm for 4 hours. Centrifugation at 1,500 rpm for 15 minutes removes any undispersed big chunks. The graphite powder in the aqueous solution has a shelf life up to 6 months (FIG. 15).

### Example 2

In another example, after four hours of shear mixing and separation, about 8.9 wt % of graphite can be dispersed into the solution reaching a concentration of ˜0.4 mg/mL. From methylene blue adsorption test, the dispersed graphene nanosheets have an accessible surface area of 526 m²/g. The graphene dispersion can be further filtered to have graphene nanosheets deposited on the 0.65-μm polyethersulfone (PES) membrane.

The filtered film shows a good electrical conductivity of ˜700 S/m. From Raman spectra (FIG. 9), the filtered film from graphene dispersion after shear mixing exhibits a low D/G ratio of ˜0.3, indicating a low defect density of the obtained graphene nanosheets, which is also in agreement with the measured good electrical conductivity. Elemental analysis of the filtered film from the graphene dispersion reveals a low oxygen content of 4.19 wt % along with a high carbon content of 87.91 wt %, corresponding to a C/O weight ratio of 20.98. Furthermore, the XRD pattern recorded from the filtered film from the graphene dispersion, shows a peak at around 26.7°, representing the carbon (002) plane and the existence of few-layer graphene with a space distance of ˜0.33 nm (FIG. 10). The thermal stability of the dispersed graphene is also tested by Thermogravimetric Analysis (TGA) using the filtered graphene nanosheets from the shear mixed dispersion as the sample. Three peaks at 360.2° C., 522.2° C., and 657.0° C., respectively, are recorded using air as the flowing gas.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

1. A method for processing carbonaceous compositions, the method comprising:
combining a first carbonaceous composition with a first acidic composition to form a second acidic composition, the first carbonaceous composition comprising carbonaceous material comprising graphite;
filtering the second acidic composition to form a second carbonaceous composition;
combining a surfactant with the second carbonaceous composition to form a third carbonaceous composition; and
shearing the third carbonaceous composition to form a dispersion, the dispersion comprising graphene.

2. The method of claim 1, further comprising:
disposing one or more carbonaceous electrodes in a first fluid to form a primary composition, the one or more carbonaceous electrodes comprising graphite;
separating a second fluid from the composition; and
combining the second fluid with an alkaline composition to form a precipitate.

3. The method of claim 2, further comprising:
filtering the precipitate;
collecting a supernatant; and
combining the supernatant with a salt solution to produce a carbonate salt, the salt solution comprising an alkaline composition.

4. The method of claim 2, wherein the alkaline composition comprises a carbonate salt, sodium carbonate, or combinations thereof.

5. The method of claim 2, wherein the first fluid, the second fluid, or both comprises water, ethanol, or both.

6. The method of claim 1, wherein the method further comprises separating the third carbonaceous composition to obtain a fourth carbonaceous composition, the fourth carbonaceous composition comprising graphite.

7. The method of claim 6, wherein separating the third carbonaceous composition to obtain a fourth carbonaceous composition comprises centrifuging the third carbonaceous composition to pellet the fourth carbonaceous composition.

8. The method of claim 1, wherein combining the surfactant with the second carbonaceous composition comprises adding the surfactant to a final concentration (% w/w) of about 0.05 wt % to about 10 wt %.

9. The method of claim 1, wherein the surfactant comprises a hydrocarbon-based ionic surfactant, an aromatic ionic surfactant, an aromatic non-ionic surfactant, a non-aromatic surfactant, an ionic liquid, or a polymeric surfactant.

10. The method of claim 1, wherein the surfactant comprises a hydrocarbon-based ionic surfactant, comprising a C1-C8 hydrocarbon, a C9-C14 hydrocarbon, or C16-C35 hydrocarbon.

11. The method of claim 1, wherein the surfactant comprises an aromatic surfactant, the aromatic surfactant comprising 1-pyrene sulfonic acid sodium salt.

12. The method of claim 1, wherein the surfactant comprises an aromatic non-ionic surfactant, the aromatic non-ionic surfactant comprising porphyrins, porphycene, corrphycene, hemiporphycene, isoporphycene, or a combination thereof.

13. The method of claim 1, wherein the surfactant comprises an ionic liquid, the ionic liquid comprising 1-hexyl-3-methyl imidazolium hexafluorophosphate (HMIM).

14. The method of claim 1, wherein separating a fluid comprises removing lithium.

15. The method of claim 1, wherein the method further comprises heating the composition to a temperature 50-90°C.

16. The method of claim 1, wherein the second carbonaceous composition has a pH of less than 1.0.

17. The method of claim 1, wherein the first acidic composition has a pH of less than 0.5.

18. The method of claim 1, wherein a weight ratio of the first acidic composition to the first carbonaceous composition is 10:1 to 100:1.

19. The method of claim 1, wherein the method further comprises washing the second carbonaceous composition with water after filtering the second acidic composition.

20. The method of claim 1, wherein the method further comprises drying the second carbonaceous composition at a temperature of at least 50°C.
